(19) United States
(12) Patent Application Publication
(10) Pub. No.: US 2001/0015788 A1
(43) Pub. Date: Aug. 23, 2001

(54) Displaying system for displaying information on display

(76) Inventors: Makiko Mandai, Osaka (JP); Nobuyuki Taniguchi, Nishinomiya-Shi (JP); Masahide Ueda, Kashihara-Shi (JP); Yutaka Tsurumoto, Kobe-Shi (JP); Koichi Kohriyana, Amagasaki-Shi (JP); Masashi Nishikado, Osaka (JP)

Correspondence Address: SIDLEY AUSTIN BROWN & WOOD, 717 NORTH HARWOOD, SUITE 3400, DALLAS, TX, 75201, US

(21) Appl. No.: 09/748,767

(22) Filed: Dec. 26, 2000

(30) Foreign Application Priority Data
Dec. 27, 1999 (JP) 11-369896
Dec. 28, 1999 (JP) 11-373307
Dec. 28, 1999 (JP) 11-373308
Dec. 28, 1999 (JP) 11-373310
Jul. 25, 2000 (JP) 2000-223267

(51) Int. Cl. C09K 19/02; G02F 1/1345

(52) U.S. Cl. 349/172; 349/149

(57) ABSTRACT

A liquid crystal display of the present invention includes first and second substrates. The first substrate has a surface supporting thereon a plurality of parallel first electrodes. The second substrate has a first surface and second surface opposed to the first surface. The first surface supports thereon a plurality of parallel second electrodes. The second substrate is positioned so that the first surface opposes the surface of the first substrate to define a gap therebetween and the first and second electrodes cross with each other. A memory type liquid crystal is filled in the gap. A plurality of first and second terminals are positioned on the second surface and electrically connected with the first and second electrodes, respectively, so that the first and second terminals are capable of being connected with an external device.

### TECHNICAL FIELD

The present invention relates to a display, e.g., a liquid crystal display (LCD) which is preferably used for a rewritable data or information carrier in the form of card. Also, the present invention relates to a system for displaying information.

### BACKGROUND OF THE INVENTION

Conventionally, an information carrier in the form of card has been used so widely. Among other things, the card made of plastic or paper is often used, for example, as a personal identification that is issued for the visitor of the company or a ticket for the amusement facilities. Unfortunately, due to the lack of rewritability and then reusability thereof, most of the dead cards are likely to be discarded without any further reuse.

Under the circumstances, inventors of the present invention have been studying a rewritable and then reusable card that includes a display of a “memory type” liquid crystal (LC), which maintains a displaying state or molecular structure without requiring any power supply. The memory type LC may be cholesteric LC or ferroelectric LC.

In general, the display card with the LC can be driven through a controller and drive ICs. The controller and drive ICs, if they are incorporated in the card, will increase the cost of the card, which is less economical. Also, the card with the controller and drive ICs will be thicker or larger in size. Further, the controller and drive ICs will be damaged even with a slight external force or shock.

Another requirement will be imposed to the display card to endure a large number of electrical connections required for the frequent input and output with an external read/write device. For this purpose, the display card should be designed to make electric contacts with the external device without any difficulty.

### SUMMARY OF THE INVENTION

Therefore, an object of the present invention is to provide a display that is capable of driving with less drive ICs incorporated therein and making electric connections with an external device with ease. Another object of the present invention is to provide a display in the form of the card. Another object of the present invention is to provide an improved displaying system.

Accordingly, an LCD of the present invention includes a first substrate having a surface, the surface supporting thereon a plurality of first electrodes each extending in a certain direction; a second substrate having a first surface and second surface opposed to the first surface, the first surface supporting thereon a plurality of second electrodes each extending in a certain direction, the second substrate being positioned so that the first surface opposes the surface of the first substrate to define a gap therebetween and the first and second electrodes cross with each other; a memory type liquid crystal filled in the gap; and a plurality of first and second terminals positioned on the second surface and electrically connected with the first and second electrodes, respectively, so that the first and second terminals are capable of being connected with an external device that transmits a signal through the first and second terminals to the first and second electrodes, respectively.

A displaying system of the present invention comprises an apparatus for transmitting data into the LCD, which includes a plurality of outputs provided for the terminals of the LCD, respectively; and a circuit for transmitting signals of an image through the outputs to the terminals associated thereto.

According to the displaying system of the present invention, the LCD or card can be reused repeatedly, which is advantageous for the reduction of garbage and protection of resources. Also, the LCD can continue to display the information without requiring any power supply.

### BRIEF DESCRIPTION OF THE DRAWINGS

FIG. 1 is an enlarged partial cross sectional view of a first embodiment of the LCD according to the present invention;

FIG. 2 is a perspective view of each displaying layer of the LCD in FIG. 1;

FIG. 3 is a perspective view of the LCD in FIG. 1 in the form of a card;

FIG. 4A is a top plan view of the LCD in FIG. 1;

FIG. 4B is a cross sectional view taken along the line IVb-IVb in FIG. 4A;

FIG. 4C is a cross sectional view taken along the line IVc-IVc in FIG. 4A;

FIG. 4D is a bottom plan view of the LCD in FIG. 1, showing an electric terminal panel that supports terminals for the connection thereof with an external write device and terminals electrically connected with scan or signal electrodes;

FIG. 5A is a bottom plan view of the LCD in FIG. 1, showing that the terminals electrically connected with the scan or signal electrodes are connected in a one-to-one correspondence with the terminals for the connection thereof with an external write device;

FIG. 5B is a bottom plan view of the LCD in FIG. 1, showing that the terminals electrically connected with respective signal electrodes of the displaying layers are connected in a three-to-one correspondence with the terminals for the connection thereof with an external write device;

FIG. 6 is a graph of the luminous reflectance Y of the cholesteric LC, as a function of the voltage applied to the LC for setting a displaying state after it has been transformed to the focal-conic state;

FIG. 7 is a partial schematic cross sectional view of an external write device and the electric terminal panel of the LCD according to the present invention;

FIG. 8 is a schematic perspective view of a displaying system with the write device;

FIG. 9 is a block diagram of the control circuit of the write device;

FIG. 10 is a schematic perspective view of another displaying system;

FIG. 11 is a top plan view of the electric terminal panel, showing another arrangement of the terminals for the connection thereof with an external write device and the terminals electrically connected with the scan or signal electrodes;

FIG. 12 is a top plan view of the electric terminal panel on which the drive circuits for driving the scan and the signal electrodes are provided;

FIG. 13 is a partial cross sectional end view of the LCD, showing an electric connection between the electric terminal panel and the electrodes of the display panel using through-holes;

FIG. 14 is a top plan view of a display region of a second embodiment of the LCD according to the present invention, which includes two display zones with different resolutions;

FIG. 15 is a top plan view of another display region of a second embodiment of the LCD according to the present invention;

FIG. 16 is a top plan view of a display region of a third embodiment of the LCD according to the present invention, which includes color and monochrome display zones;

FIG. 17A is a bottom plan view of a third embodiment of the LCD according to the present invention, showing that the terminals electrically connected with the scan or signal electrodes are connected in a one-to-one correspondence with the terminals for the connection thereof with an external write device;

FIG. 17B is a bottom view of a third embodiment of the LCD according to the present invention, showing that the terminals electrically connected with respective signal electrodes of the displaying layers are connected in a three-to-one correspondence with the terminals for the connection thereof with an external write device;

FIG. 18 is a block diagram a first embodiment of a displaying system according to the present invention;

FIG. 19 is a plan view of an electric terminal panel on which a magnetic portion for recording information is provided;

FIG. 20 is a block diagram of an IC card used in a second embodiment of the displaying system according to the present invention;

FIG. 21 is a perspective view of a card used in a third embodiment of the displaying system according to the present invention;

FIG. 22 is a block diagram of a write device used in a third embodiment of the displaying system according to the present invention;

FIG. 23 is a perspective view of a read/write device or ticket inspector, used in a third embodiment of the displaying system according to the present invention;

FIG. 24 is a block diagram of the ticket inspector in FIG. 23;

FIG. 25 is a flowchart showing the operation of the ticket inspector in FIG. 23;

FIG. 26 is a perspective view of a card provided with a magnetic recording portion, which is used in a fourth embodiment of the displaying system according to the present invention;

FIG. 27 is a block diagram of the ticket inspector used in a fourth embodiment of the displaying system according to the present invention;

FIG. 28 is a block diagram of an IC card used in a fifth embodiment of the displaying system according to the present invention;

FIG. 29 is a block diagram of a read/write device or ticket inspector, used in a fifth embodiment of the displaying system according to the present invention;

FIG. 30 is a block diagram of an IC card used in a sixth embodiment of the displaying system according to the present invention;

FIG. 31 is a block diagram of a read/write device, which is a ticket inspector, used in a sixth embodiment of the displaying system according to the present invention; and

FIG. 32 is a perspective view of a card used in a seventh embodiment of the displaying system according to the present invention.

### DETAILED DESCRIPTION OF THE PREFERRED EMBODIMENTS

With reference to the drawings, various embodiments of the display and the displaying system according to the present invention will be described hereinafter. Note that like parts and elements are designated by like reference numerals throughout the drawings.

### Liquid Crystal Display Element

First Embodiment

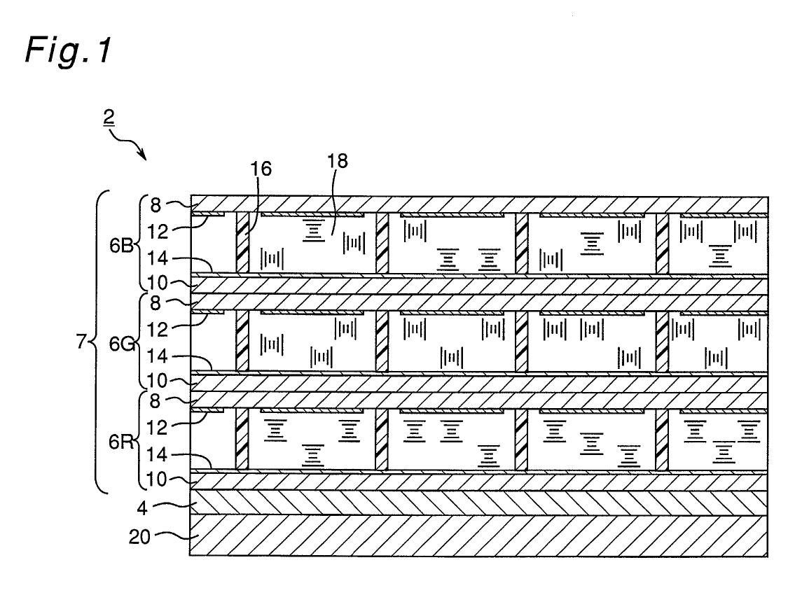

FIG. 1 shows a first embodiment of the LCD according to the invention. The LCD in the form of flat panel generally indicated by reference number 2 includes a light absorbing layer 4 and a display panel 7 provided on the light absorbing layer 4. The display panel 7 is comprised one or more displaying layers 6, preferably red, green and blue displaying layers 6R, 6G, 6B positioned one on top the other. The displaying layers 6R, 6G, 6B have substantially identical structures. In the display panel 7 shown, the red, green, and blue displaying layers 6R, 6G, 6B are deposited in this order on the light absorbing layer 4.

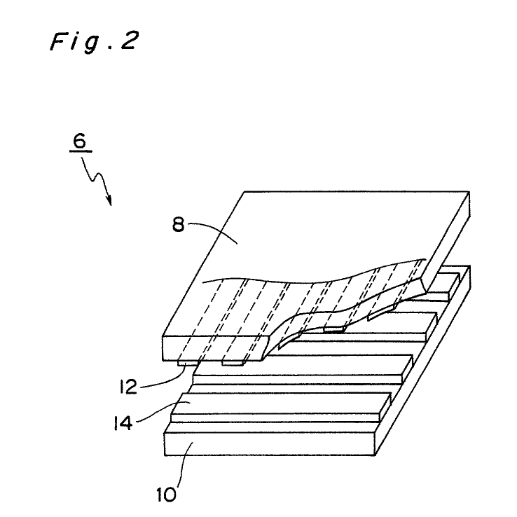

As best shown in FIG. 2, each displaying layer 6 includes a pair of transparent substrates, i.e., upper and lower substrates 8, 10, spaced apart from the other to form a predetermined gap therebetween. A plurality of transparent electrodes, i.e., column electrodes 12 arranged parallel to the direction extending across the front and rear surfaces of the drawing of FIG. 1 are formed on the lower surface of the upper substrate 8. Likewise, a plurality of transparent electrodes, i.e., row electrodes 14 arranged laterally in FIG. 1 (i.e. perpendicular to the longitudinal direction of the column electrodes 12) are formed on the upper surface of the lower substrate 10. In each layer, the substrates 8, 10 are securely held by columns 16 extending in the thickness direction of the LCD 2. Preferably, the columns 16 are made of suitable resin. Also, to maintain an even gap, spacers not shown are provided between the substrates 8, 10, as known in the art. If necessary, an orientational control layer or an insulating layer may be provided. Each displaying layer 6 further includes cholesteric liquid crystal 18, which is used as light-modulating layer contained between the opposing upper and lower substrates 8, 10. As is well known to those in the art, the cholesteric LC 18 can be switched between a “planar” state where the cholesteric LC 18 reflects light having a predetermined wavelength including the visible or color light spectrum, a “focal-conic” state where the cholesteric LC 18 transmits the visible light, and an intermediate or “gray scale” state between the planar and the focal-conic states. Preferably, the cholesteric LC 18 is a chiral nematic LC, which is comprised of nematic LC to which any chiral compound is added.

Although in the present embodiment the LCD with three displaying layers is described, an LCD with one or more displaying layers is included within the scope of the present invention.

On the rear side or lower side of the display panel 7 remote from the observer, a panel 20 having a plurality of electric terminals is provided. The panel 20 is removably connected with an external write device not shown for writing information in the LCD 2. As will be described hereinafter, the electric terminal panel 20 is electrically connected with the column and row electrodes 12, 14, so that, when the electric terminal panel 20 is connected with the external write device, a drive circuit of the write device applies a predetermined voltage to the specific column and row electrodes 12, 14. This allows the LC domains at a pixel defined by the specific column and row electrodes 12, 14 to be changed between planar, focal-conic and intermediate states. As is well known to those in the art, these states is maintained even if the voltage does not continue to be applied.

Generally, a matrix driving technique is employed for such application of the drive voltage. Referring to FIG. 2, while one of the column or scan electrode 12 is firstly selected by applying a predetermined voltage to the electrode, all or some of the row or signal electrodes 14, the longitudinal axis of which is at right angles to that of the scan electrode 12, are applied simultaneously or sequentially with respective voltages based on image information to be displayed. Consequently, the state of the LC 18 located between the selected scan electrode 12 and the signal electrodes 14 is changed. By repeating this method for all scan electrodes 12 sequentially, LC 18 is applied with a matrix of desired voltages. The displaying layers 6R, 6G, 6B are controlled sequentially or simultaneously using the matrix driving technique, so that the LCD 2 displays a full-color image.

Although in the present invention the column and the row electrodes 12, 14 are the scan and the signal electrodes, respectively, the column and the row electrodes 12, 14 may be the signal and the scan electrodes, respectively.

Since the light absorbing layer 4 is located at the lowest position remote from the observer, when all of the LC cells are in the focal-conic state, incident light transmits through the displaying layers 6R, 6G, 6B and is absorbed by the light absorbing layer 4, so that the LCD 2 displays black color. For this purpose, the light absorbing layer 4 may be a black film. As an alternate to the light absorbing layer 4, a black coating ink may be applied on the lowest surface of the display panel 7.

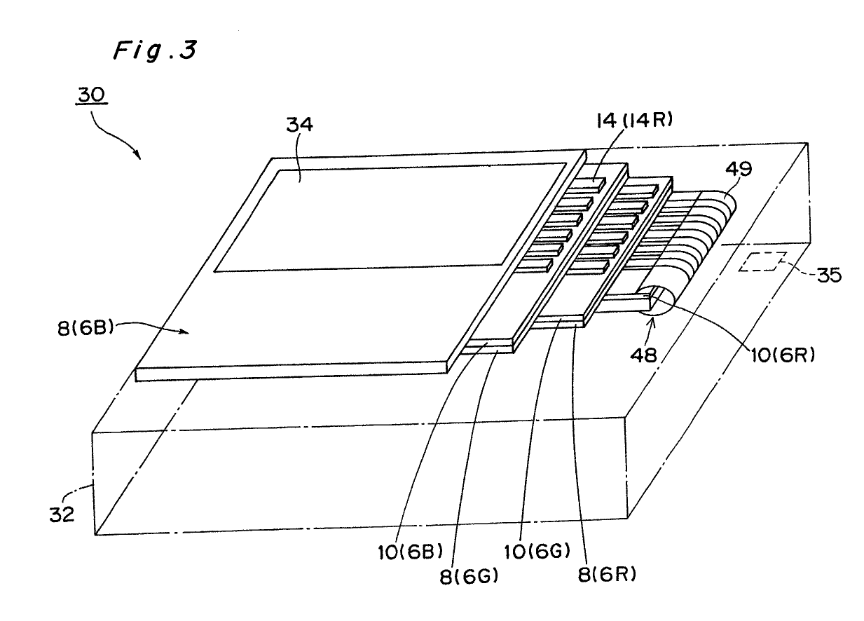

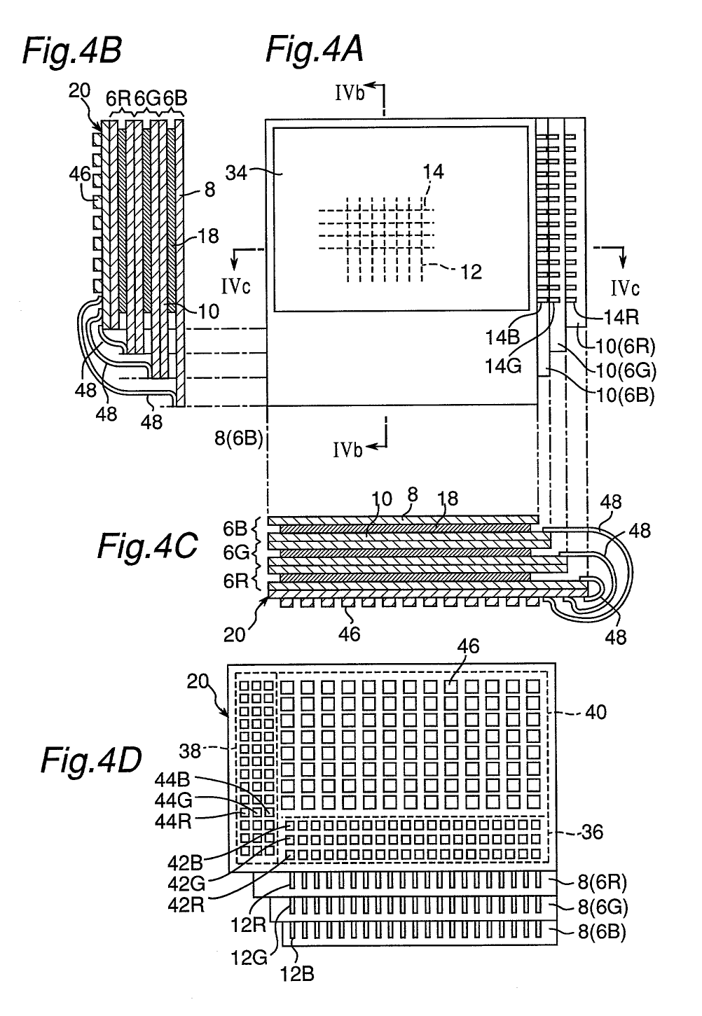

FIG. 3 shows a schematic perspective view of the LCD 2 of the present invention in the form of a thin card 30. The card 30 includes a housing 32 in which the LCD in FIG. 1 is incorporated, so that the blue displaying layer 6B and the electric terminal panel 20 are located on the front and the rear surfaces, respectively, of the housing 32. Referring to FIG. 4A, reference number 34 indicates a display region having a matrix of pixels defined by the scan electrodes 12 and the signal electrodes 14. In case where the card 30 is used in the form of an ID card of a visitor, for example, the visitor's image or name is displayed on the region 34. Reference number 35 indicates a portion for recording additional information representative of prohibition or permission of writing information on the card, updating or erasing the information. Alternatively or in addition, the portion 35 may an indicator for indicating a feature of any one of the scan electrodes 12, the signal electrodes 14 and the plurality of terminals of the panel 20 for identifying, for example, the configuration or arrangement of the selected one. Accordingly, even if the LCD has its own configuration or arrangement of the electrodes and/or terminals, an external write device can sense the additional information and therefore write information adequately on the LCD based on the sensed information. The portion 35 may be configured in various ways such as in the form of a recess, a bore, a notch or barcode, the size and the location of which being designed so that it does not interfere with the use of the card. Preferably, the portion 35 is located near the end portion of the card.

As shown in FIG. 4D, the electric terminal panel 20 includes three zones, namely, a connecting zone 36 for the connection thereof with the scan electrodes 12, a connecting zone 38 for the connection thereof with the signal electrodes 14, and a connecting zone 40 for the connection thereof with an external information write device. In the connecting zones 36, 38, 40, pluralities of terminals 42, 44, 46, for the connection thereof with the scan electrodes 12, the signal electrodes 14, and the external write device, respectively, are provided.

More specifically, as shown in FIG. 4D, near a first end side where the lead wires of the scan electrodes 12 of the displaying layers 6R, 6G, 6B are extended out in the form of steps, a row of terminals 42R for the connection thereof with the scan electrodes 12R of the red displaying layer 6R, a row of terminals 42G for the connection thereof with the scan electrodes 12G of the green displaying layer 6G, and a row of terminals 42B for the connection thereof with the scan electrodes 12B of the blue displaying layer 6B are located. The rows of terminals 42R, 42G, 42B extend substantially perpendicular to the scan electrodes 12. As shown in FIG. 4B, the scan electrodes 12R, 12G, 12B of each displaying layer 6R, 6G, 6B are electrically connected with their respective terminals 42R, 42G, 42B via leads 49 (see FIG. 3) formed on its respective flexible substrate 48.

Similarly, as shown in FIG. 4A, near a second end side where the lead wires of the signal electrodes 14 of the displaying layers 6R, 6G, 6B are extended out in the form of steps, a column of terminals 44R for the connection thereof with the signal electrodes 14R of the red displaying layer 6R, a column of terminals 44G for the connection thereof with the signal electrodes 14G of the green displaying layer 6G, and a column of terminals 44B for the connection thereof with the signal electrodes 14B of the blue displaying layer 6B are located. The columns of terminals 44R, 44G, 44B extend substantially perpendicular to the signal electrodes 14.

As shown in FIG. 4C, the signal electrodes 14R, 14G, 14B of each displaying layer 6R, 6G, 6B are electrically connected with the respective terminals 44R, 44G, 44B via leads 49 (see FIG. 3) formed on its respective flexible substrate 48. Note that, for clarity, the flexible substrates 48 are omitted in FIGS. 4A and 4D. Also, in FIG. 3 is shown only the flexible substrate 48 which connects between the signal electrodes 14R of the red displaying layer 6R and the connecting zone 38 (see FIG. 4).

The leads 49 and the terminals 42, 44 may be connected with each other by thermocompressive soldering or via an anisotropic conductive film. The leads 49 and the electrodes 12, 14 may also be connected with each other by thermocompressive soldering or via an anisotropic conductive film.

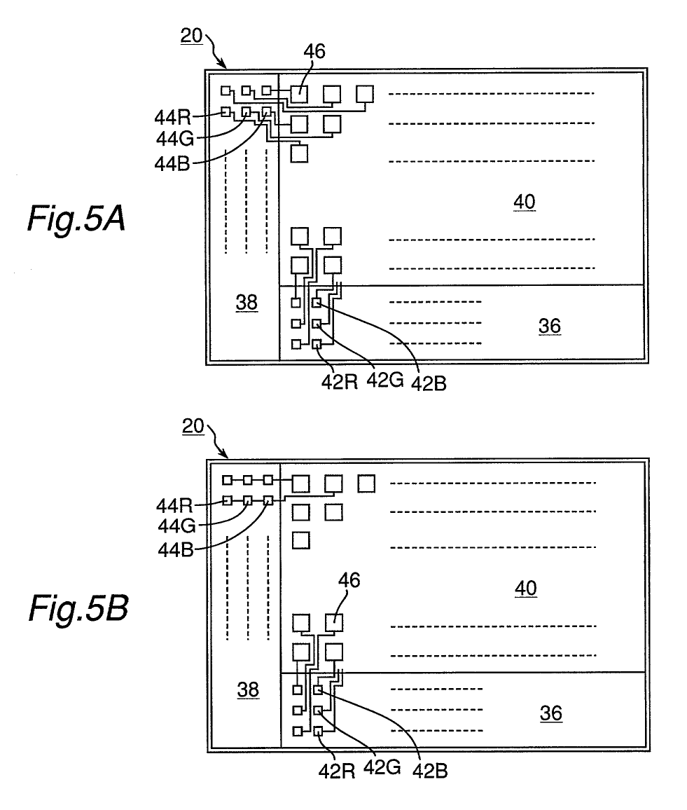

As shown in FIG. 5A, the terminals 46 for the connection thereof with an external write device may be electrically connected in a one-to-one correspondence with the terminals 42 electrically connected with the respective scan electrodes 12 or the terminals 44 electrically connected with the respective signal electrodes 14. Alternatively, as shown in FIG. 5B, with regard to the terminals 44 electrically connected with the signal electrodes 14, the terminals 44R, 44G, 44R may be electrically connected in a three-to-one correspondence with the terminals 46. The former configuration allows the writing of information to be performed reliably in a reduced time. The latter configuration allows the number of the terminals 46 for the connection with the external write device to be reduced, although the writing time or the time necessary to input voltage signals to the electrodes becomes longer.

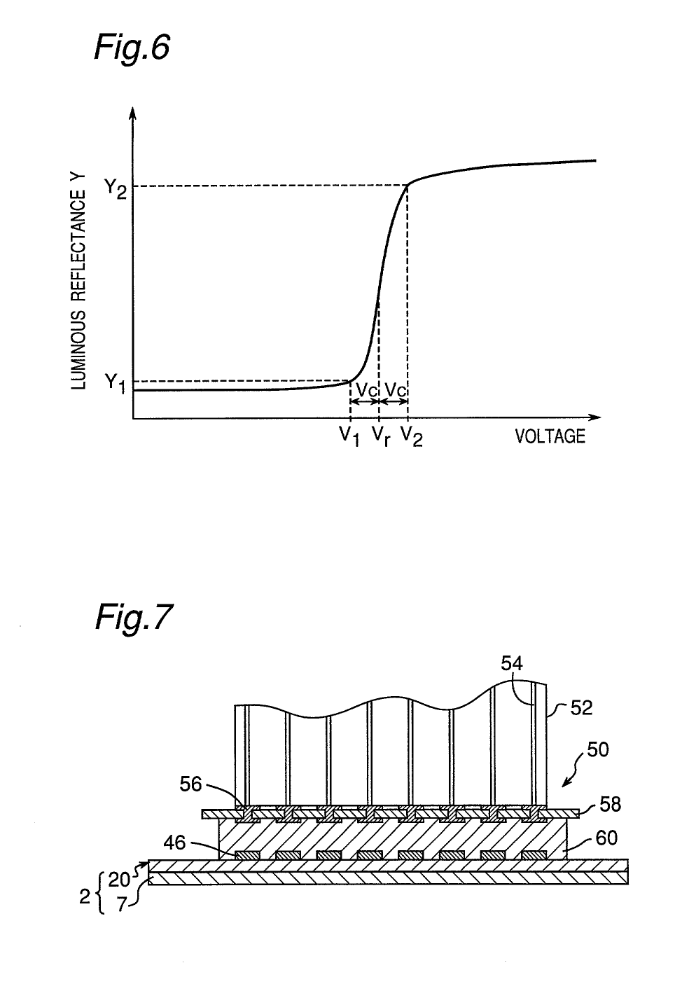

Referring to FIG. 6, the reason why the latter configuration can be employed will now be described. FIG. 6 is a graph of the luminous reflectance Y of the cholesteric LC, as a function of the voltage applied to the LC for setting a displaying state after it has been transformed to the focal-conic state. For example, for the gray scale display with the luminous reflectance in the range of Y1 to Y2, the cholesteric LC is initialized to the focal-conic state and then is applied with a voltage in the range of V1 to V2. In case where the matrix drive technique is employed as in the present embodiment, a scan electrode is preferably applied with a voltage Vr[=(V1+V2)/2], and a signal electrode is applied with a voltage in the range of −Vc to Vc corresponding to a desired display state. Generally, the voltage Vc can be set to a relatively lower value so that, even if the voltage is applied to LC, its displaying state is not changed, so that an identical voltage can be applied to the signal electrodes 12R, 12G, 12B in the same row of the displaying layers 6R, 6G, 6B. More specifically, one of the scan or column electrodes of a first displaying layer is selected by applying a voltage, and a signal or row electrode is applied with a predetermined signal voltage, so that these voltages induce an electric field which can cause a state change in the LC domains at a pixel defined by the column and the row electrodes. At the same time, the predetermined signal voltage is also applied to other pixels opposed to non-selective scan electrodes of the first displaying layer, and to the other displaying layers having signal electrodes electrically connected with the signal electrodes of the first displaying layer. The signal voltage, however, is insufficient to induce a state change, so that displaying states of the other pixels of the first displaying layer and the other displaying layers are maintained. The writing of the LCD 2 is performed by the writing of information in the displaying layers sequentially, although the time necessary to write information is longer than that of the former configuration where the signal electrodes of the displaying layers are not electrically connected with each other, and therefore the information can be written in the displaying layers simultaneously.

FIG. 7 shows an exemplary method of connecting between an information write device and the electric terminal panel 20 of the LCD 2 or card 30. The information write device 50 shown includes a flexible substrate 52 on which a plurality of leads 54 are provided parallel to each other, and a panel 58 having holes through which terminals 56 are extended and are fixed in place. One ends of the terminals 56 are connected with their respective leads 54. On the other ends of the terminals 56, an anisotropic conductor 60 is adhered for making contacts with the terminals 46 of the panel 20 to electrically connect the terminals 46 with the terminals 56. A suitable means may be used for positioning the connecting terminals 46 of the LCD 2 or card 30 with regard to the terminals 56 of the information write device 50.

Preferably, the anisotropic conductor 60 may be an anisotropic conductive rubber. The anisotropic conductor offers the advantage that a reliable electric connection between terminals can be made without any difficulty, and connection and disconnection therebetween can be repeated. Alternatively, the terminals 46 and the terminals 56 may be designed so that they connect mechanically with each other to reduce electrical losses.

As described above, since the LCD 2 according to the present invention has the electric terminal panel 20 separated from the display panel 7, the terminals 46 and/or connecting lines can be formed on the panel 20 using a metal with lower resistance before the panel is installed in the LCD. This allows the LCD to be easily manufactured, which can connect with an external write device without any difficulty. Also, since the connecting terminals 46 can be located on a wide range of the rear surface of the LCD 2, the connection with an external write device can be made easily.

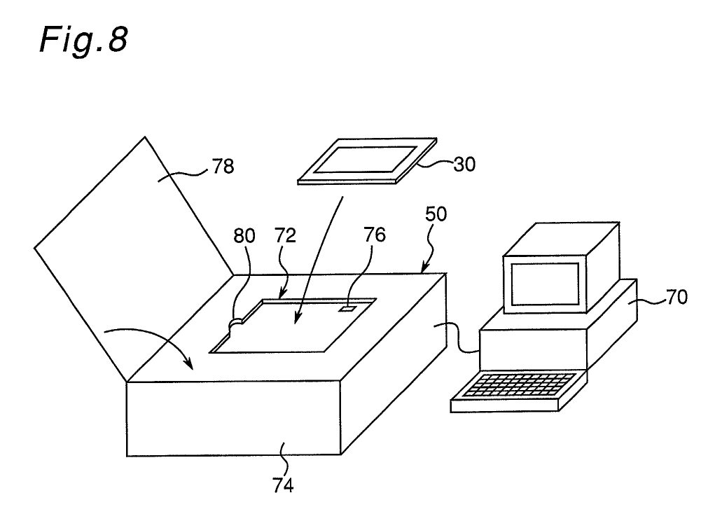

FIG. 8 is a schematic perspective view of an information recording system or displaying system including the write device 50. The system includes the LCD or card 30, the write device 50 for writing image information in the card 30, and an external host computer 70 for transmitting image data to the write device 50 when necessary. The write device 50 comprises a housing 74 having a recess 72 formed therein, the profile of which being substantially identical to that of the card 30 so that it is fitted therein. The recess 72 has a flat bottom on which the connecting terminals 56 corresponding to the connecting terminals 46 on the rear surface of the card 30, the terminals 56 being covered with the anisotropic conductor 60. The side faces of the recess 72 permits the card 30 to be positioned in place so that the terminals 46 of the card 30 are suitably opposed to the terminals 56 of the write device 50. A control circuit not shown is incorporated in the housing 74 for receiving the image data from the host computer 70. A sensor 76 is provided on the bottom of the recess 72 for detecting the additional information recorded in the portion 35 of the card 30. The sensor 76 may be a mechanical or optical sensor.

A movable cover 78 made of a transparent solid plate is hinged about one end side of a front surface of the housing 74 so that the cover 78 closes the recess 72 in which the card 30 is inserted, forcing the card 30 to be in contact with the anisotropic conductor 60 to electrically connect the terminals 46 of the card 30 with the terminals 56 of the write device 50. For the removal of the card 30 from the recess 72 without any difficulty, a notch 80 may be provided along a portion of one side face of the recess 72 as shown in FIG. 8. Alternatively, a mechanism may be provided for pushing out the card 30 from the recess 72 as the cover 78 is moved away from the position where it closes the recess 72.

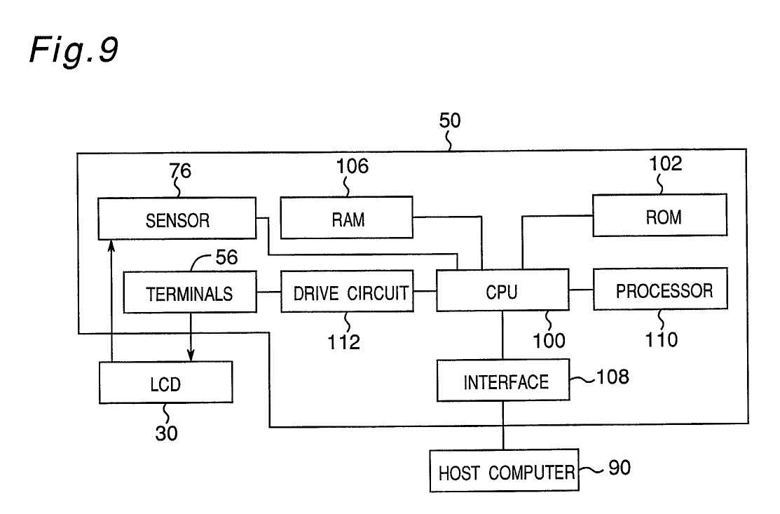

FIG. 9 is a block diagram of the control circuit or data output circuit of the write device 50. The control circuit includes a central processor unit (CPU) 100, which is electrically connected with a read only memory (ROM) 102, a random access memory (RAM) 106, an interface 108 for receiving data transmitted from external devices such as the host computer 70, a processor 110 for processing the data transmitted from the interface 108, a drive circuit 112 for applying a voltage to the connecting terminals 56 based on the image data, and the sensor 76 for reading the additional information on the card 30.

The CPU 100 controls the drive circuit 112 based on the received image data to write image information in the card 30 or LCD. The sensor 76 detects the additional information to identify the configuration or arrangement of the electrodes of the card 30 so that the drive circuit 112 is controlled in a way suitable to the configuration or arrangement.

Instead of receiving image data from the external devices, a storage medium for storing the data may be incorporated in the write device 50 to read the data from the storage medium, so that the information corresponding to the data is displayed on the card 30.

In case where the signal electrodes in the same row of the displaying layers are electrically connected with one common connecting terminal as described above, the control circuit or data output circuit is designed so that the CPU 100 controls the drive circuit 112 to write image data in the displaying layers sequentially.

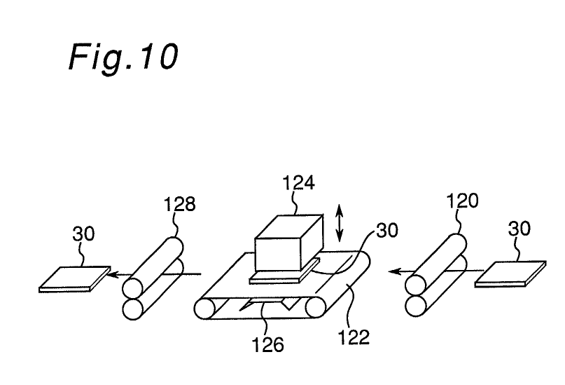

FIG. 10 is a schematic perspective partial view of another embodiment of a write device in which writing is performed as the card 30 is transported automatically. The card 30 is introduced through an entry port not shown into the write device and then is transported by a pair of transport rollers 120 to the conveying belt 122, which in turn moves the card 30 to a position where the writing of the card 30 is performed. The card 30 is positioned by a positioning mechanism not shown so that the terminals 46 of rear surface of the card 30 are suitably opposed to terminals of a write head 124, which is supported so that it moves to and from the rear surface of the card 30. The write head 124 is then forced towards the card 30 to be in contact with the card 30 to perform the writing, while a back plate 126 supports the card 30. After the writing, the card 30 is transported by the conveying belt 122 to a pair of transport roller 128, which in turn discharges the card 30 from the write device.

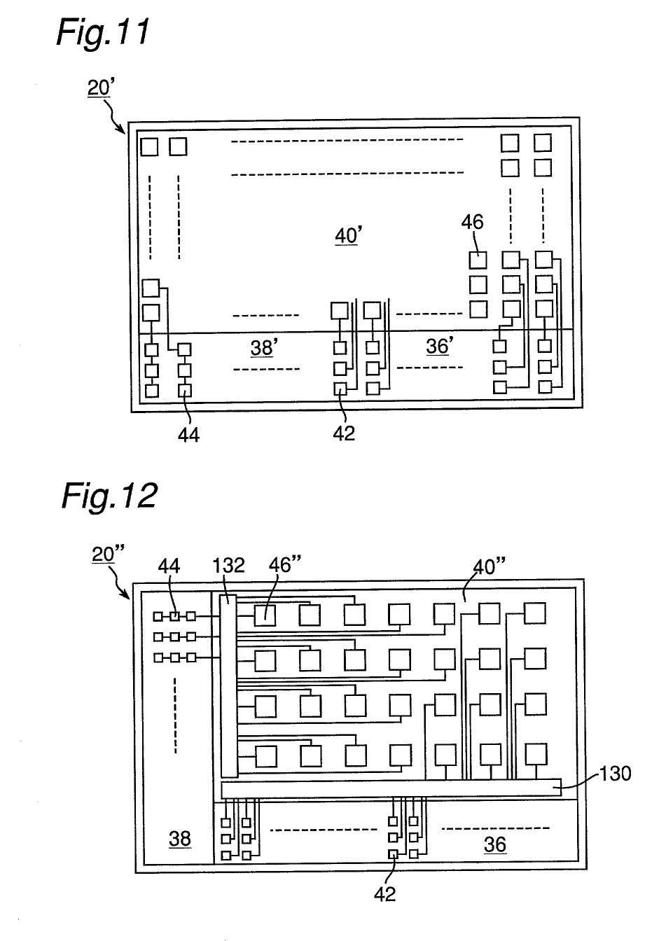

FIG. 11 is a plan view of another electric terminal panel 20′ in which a connecting zone 36′ for the connection thereof with the scan electrodes 12 and a connecting zone 38′ for the connection thereof with the signal electrodes 14 are provided on one end side of the panel 20′. In this arrangement, the lead wires of the scan and the signal electrodes are extended out to one end side of the display panel. For this purpose, the lead wires of one group selected from the scan or the signal electrodes are extended to the end side where the lead wires of the other group are extended out, for example.

FIG. 12 is a plan view of another electric terminal panel 20″ on which drive circuits 130, 132 for driving the scan and the signal electrodes, respectively, are provided. In this arrangement, although the cost of the card is increased, the number of terminals 46″ for the connection thereof with an external device is significantly reduced, resulting in more reliable connection with the device. Also, writing is performed easily by a simple procedure such as placing the LCD on a write device, compared to the arrangement in which a connector having a plug and a socket is used for the connection. This is advantageous for the automation of writing.

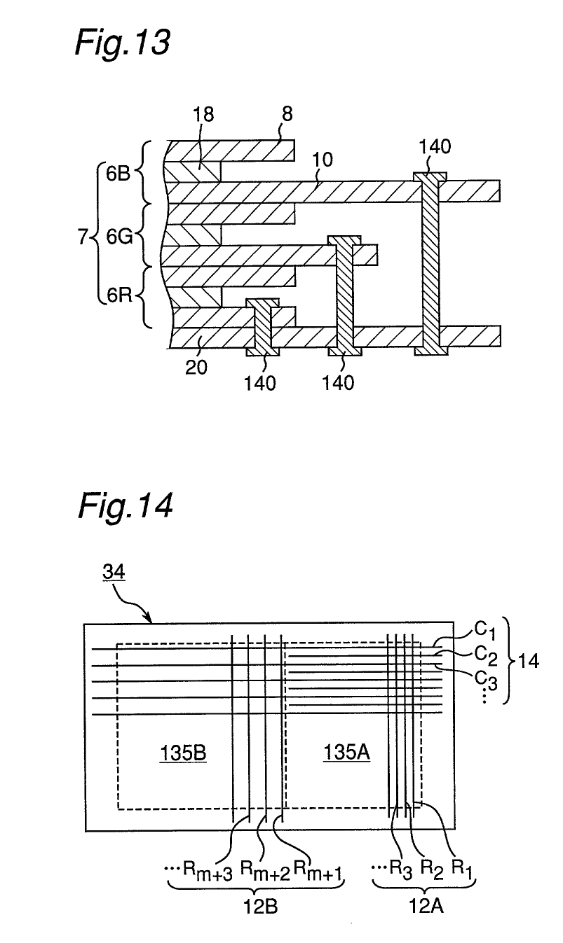

FIG. 13 is a partial cross sectional end view of the LCD, showing another embodiment of electric connection between the electric terminal panel 20 and the scan and/or the signal electrodes of the display panel 7 using through-holes. Specifically, the displaying layers 6R, 6G, 6B are formed with holes extending in the thickness direction of the display panel 7. On the other hand, the electric terminal panel 20 is formed with holes corresponding to the holes of the displaying layers 6R, 6G, 6B. Gold or solder bumps 140 are then provided through the holes as shown in the drawing to make electric connections between the displaying layers 6R, 6G, 6B and the electric terminal panel 7.

As will be apparent to those skilled in the art, instead of using the above-mentioned voltage modulation to cause a state change of the LC material, a pulse width modulation may be employed.

The LC material is not limited to cholesteric LC as long as it has the “memory” characteristic, which may be a ferroelectric or smectic LC, for example. Depending on the LC used, the method of applying voltages to the scan or the signal electrodes is different. Preferably, the pulse width modulation is used to drive the ferroelectric LC.

Second Embodiment

FIG. 14 is a plan view of a display region 34 of a second embodiment of the LCD according to the present invention, which includes two display zones with different resolutions, i.e., higher and lower resolution display zones 135A, 135B. For the better understanding, the electrodes 12, 14 are shown in perspective.

The display zones 135A, 135B are designed so that the pitch of the signal electrodes in the higher resolution display zone 135A or the number per inch thereof are different from that in the lower resolution display zone 135B.

The signal electrodes 14 shown are composed of first electrodes extending across the higher resolution display zone 135A and the lower resolution display zone 135B (e.g., C1, C3) and second electrodes extending only across the higher resolution display zone 135A (e.g., C2). The first and the second electrodes are alternately located at equally spaced intervals. Thus, the number of the signal electrodes in the lower resolution display zones 135B is one-half that in the higher resolution display zones 135A. With regard to the scan electrodes 12, on the other hand, the scan electrodes 12A (e.g., R1, R2, R3) in the higher resolution display zones 135A are at one-half the pitch of the scan electrodes 12B (e.g., Rm+1, Rm+2, Rm+3) in the lower resolution display zones 135B so that the pitches of the scan electrodes 12A, 12B in the display zones 135A, 135B are equal to those of the signal electrodes 14 in the display zones 135A, 135B, respectively.

Information required to be displayed with high quality is displayed in the higher resolution display zone 135A, while information not required to be displayed with high quality is displayed in the lower resolution display zone 135B. In case where the card 30 is used in the form of a visitor's ID card, for example, the visitor's image and name may be displayed on the higher and the lower resolution display zones 135A, 135B, respectively. The number of display zones may be more than two. For example, more than two display zones with resolutions different from each other may be provided. A plurality of display zones may have an equal resolution if at least one other display zones have a resolution different from that of the plurality of display zones. The sizes of display zones with different resolutions may be equal to or different from each other.

Although distinct signal electrodes may be used for the higher and the lower resolution display zones 135A, 135B, it is advantageous that one or more signal electrodes are extended across and commonly used in the display zones 135A, 135B, allowing the number of electrodes to be reduced.

In this embodiment, the LCD 2 has a display zone that does not require high resolution, i.e. lower resolution display zone 135B. The number of electrodes in the lower resolution display zone 135B is smaller than that in the higher resolution display zone 135A. Thus, the terminals 46 (see FIG. 4) for the connection thereof with an external write device can be reduced, which allows the cost of manufacturing the LCD and the time required to write information to be reduced.

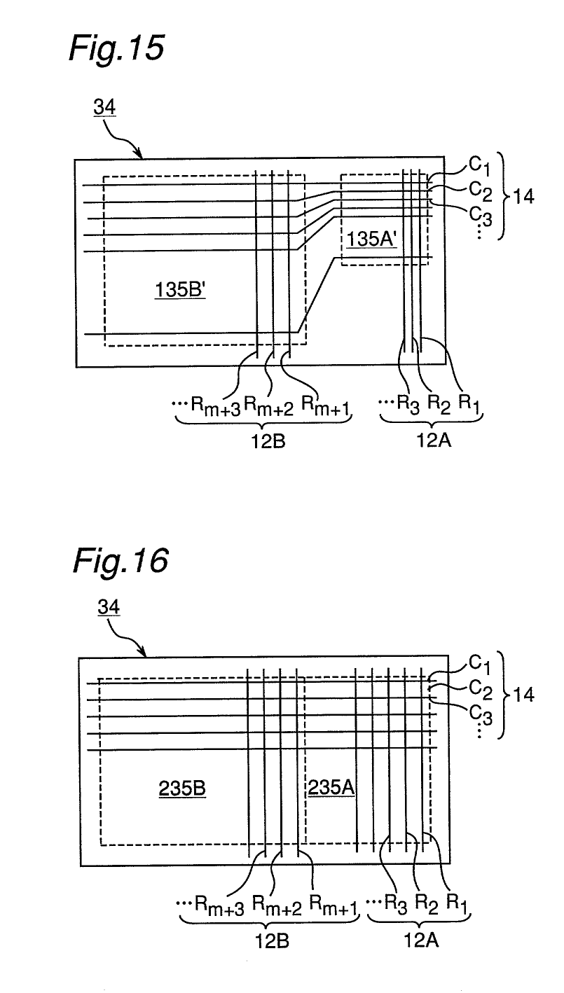

The lengths of the lower and the higher resolution display zones 135A, 135B in the longitudinal direction of the scan electrodes 12A, 12B may not be equal to each other. For example, with regard to the display region 34 shown in FIG. 15, the higher resolution display zone 135A′ is configured so that its length is shorter than that of the lower resolution display zone 135B′ in the longitudinal direction of the scan electrodes 12A, 12B. For this purpose, the signal electrodes 14 in the higher resolution display zone 135A′ are electrically connected with those in the lower resolution zone 135B′, and the numbers of the signal electrodes 14 in the higher and the lower resolution display zone 135A′, 135B′ are equal to each other. Also, the pitch of the signal electrodes 14 in the higher resolution display zone 135A′ is smaller than that in the lower resolution display zone 135B′. Further, the pitches of the scan electrodes 12A, 12B in the display zones 135A′, 135B′ are equal to those of the signal electrodes 14 in the display zones 135A′, 135B′, respectively. In this variation in which the signal electrodes 14 are angled at between the display zones 135A′, 135B′, more signal electrodes 14 can commonly be used in the two display zones 135A′, 135B′, compared to the arrangement in FIG. 14. Therefore, the number of the signal electrodes 14 can be reduced.

Although in this embodiment the liquid crystal display element is described, a display element that includes other light modulator is within the scope the present invention.

Third Embodiment

FIG. 16 is a plan view of a display region of a third embodiment of the LCD according to the present invention, which includes color and monochrome display zones, i.e., color and monochrome display zones 235A, 235B. For the better understanding, the electrodes 12, 14 are shown in perspective. The signal electrodes 14 shown (e.g., C1, C2, C3) extend across the color display zone 235A and the monochrome display zone 235B at equally spaced intervals. On the other hand, the scan electrodes 12 are composed of the electrodes 12A extending across the color display zone 235A (e.g., R1, R2, R3) and the electrodes 12B extending across the monochrome display zone 235B (e.g., Rm+1, Rm+2, Rm+3). In case where the card 30 is used in the form of a visitor's ID card, for example, the visitor's image may be displayed on the color display zone 235A. On the other hand, the visitor's name or his or her company's name may be displayed on the monochrome display zone 235B. The numbers of the color or the monochrome display zones 235A, 235B may be more than one.

Although distinct signal electrodes may be used for the color and the monochrome display zones 235A, 235B, it is advantageous that one or more signal electrodes are extended across and commonly used in the display zones 235A, 235B, allowing configuration of electrodes to be simplified.

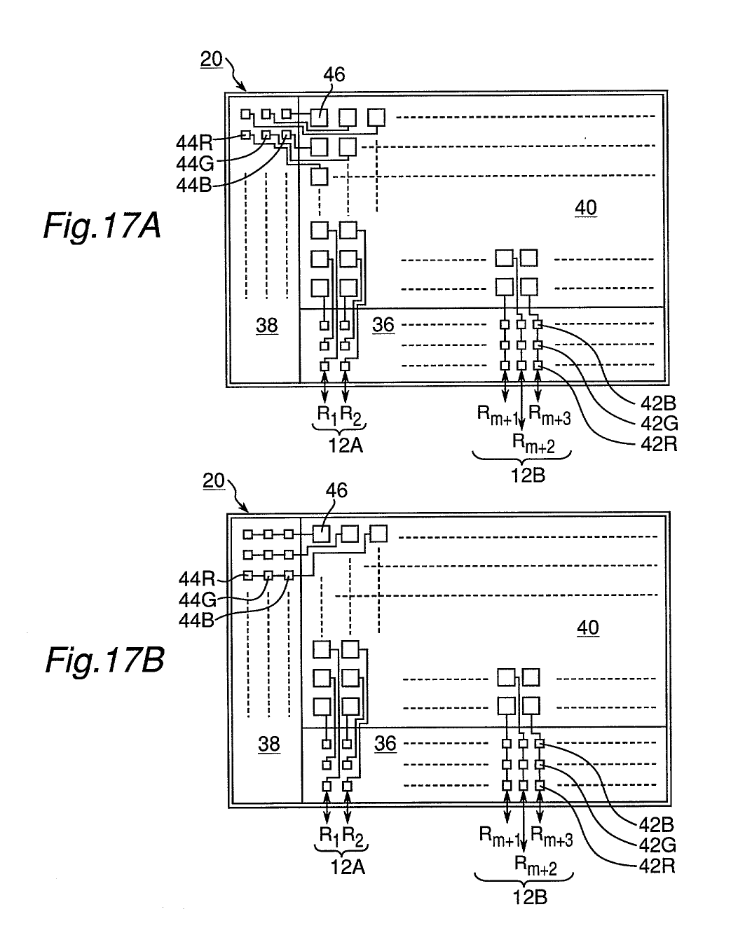

FIGS. 17A shows an exemplary connection between the terminal 42, 44 for the connection thereof with the scan or the signal electrodes 12, 14, respectively, and the terminals 46 for the connection thereof with an external write device. As shown, each terminal 46 is electrically connected with one terminal 42 electrically connected with the respective scan electrode 12A in the color display zone 235A, and is, on the other hand, electrically connected with three terminals 42R, 42G, 42B each electrically connected with the respective scan electrode 12B in the monochrome display zone 235B. Accordingly, the displaying layers 6R, 6G, 6R forming the monochrome display zone 235B are selected simultaneously so that monochrome display can be performed by one writing procedure.

Also, as shown in FIG. 17A, the terminals 46 are electrically connected in a one-to-one correspondence with the terminals 44 electrically connected with the respective signal electrodes 14. Alternatively, as shown in FIG. 17B, three terminals 44R, 44G, 44B each electrically connected with the respective signal electrode 14 may be electrically connected in a three-to-one correspondence with the terminals 46.

Referring to FIG. 17B, an exemplary method for applying a drive voltage to the scan and the signal electrodes 12, 14 will now be described. With regard to the monochrome display zone 235B, the electrodes 12B (e.g., Rm+1, Rm+2, Rm+3) in the same row of the displaying layers 6R, 6G, 6B are simultaneously applied with a voltage. In synchronism with the simultaneous application, the signal electrodes 14 are applied with the respective signal voltages, so that the LC domains of the displaying layers 6R, 6G, 6B defining one pixel are driven either to a planar state in which white color is displayed or a focal-conic state in which black color is displayed.

With regard to the color display zone 235A, the electrodes 12A (e.g., R1, R2) in the same row of the displaying layers 6R, 6G, 6B are individually applied with a voltage. In synchronism with the individual application, the signal electrodes 14 are applied with the respective signal voltages, so that each of the LC domains of the displaying layers 6R, 6G, 6B defining one pixel is individually driven to a planar, a focal-conic or an intermediate state between the planar and the focal-conic states, thereby performing color display.

In this embodiment, since monochrome display is performed by inputting identical data to three displaying layers 6R, 6G, 6B simultaneously, the amount of data and the time necessary to perform the writing can be reduced.

### Displaying System

First Embodiment

Hereinafter, a first embodiment of a displaying system according to the present invention will be described. The system comprises a card or LCD, an imaging device for obtaining digital image data of an object, and an information write device or input device for inputting the digital image data to the LCD.

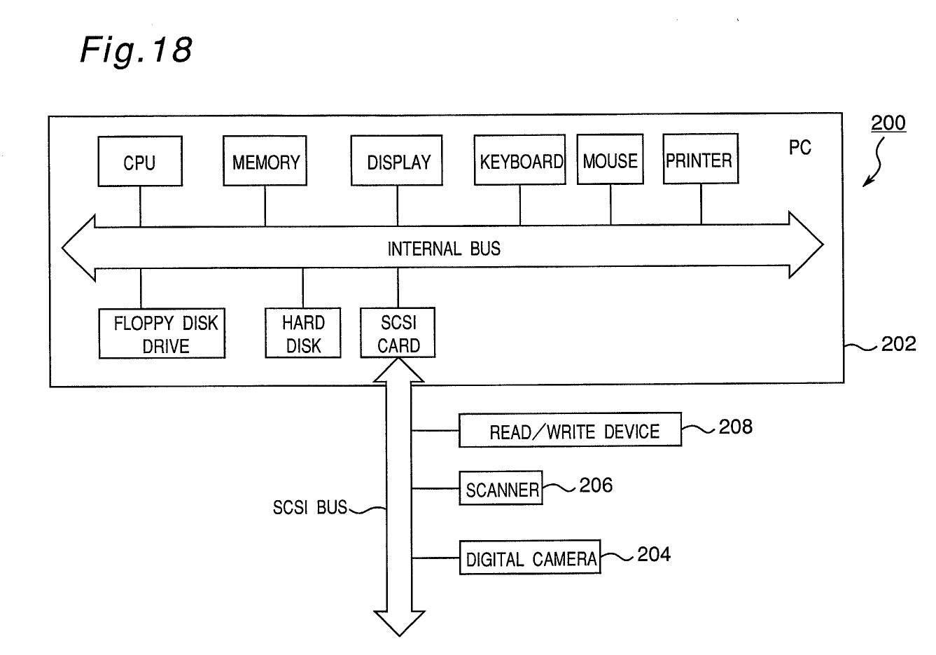

FIG. 18 is a schematic view of an exemplary displaying system 200 according to the present invention. The system 200 comprises a personal computer (PC) 202, which is electrically connected via a SCSI bus with a digital camera or digital image pickup 204, a scanner or reader 206, and a read/write device 208. The digital camera 204 is used for obtaining digital image data of an object such as a visitor's image. The scanner 206 is used for reading additional information such as character information written on a form, such as visitor's name or his or her company's name. The read/write device 208 is used for writing information obtained by the digital camera 204 and/or the scanner 206 on the card 30 and reading the information from the card 30. The SCSI bus is electrically connected, by insertion of a SCSI or ISA card into an extended slot not shown of the PC 202, with an internal bus of the PC 202. A memory, a CPU and various other devices shown of the PC 202 are electrically connected with each other via the internal bus.

The read/write device 208, which has a slot for inserting the card 30 therein, includes writing and reading elements for performing writing and reading of the card 30, respectively, when the card 30 is inserted into the slot. More specifically, the reading element is an optical reading device for optically reading a visual image displayed on the display region 34 (see FIGS. 4) of the card 30. The writing element is an information write device including terminals for writing or updating information on the card 30 when the terminals are electrically connected with the terminals on the electric terminal panel 20 of the card 30.

Preferably, the card 30 or LCD has at least two display zones with different resolutions, i.e. higher and lower resolution display zones 135A, 135B (FIG. 14). Thus, the number of electrodes in the card can be reduced, allowing the cost of manufacturing the card and the time required to write information to be reduced.

The displaying system 200 is designed so that the image of the object imaged by the digital camera 204 and the character information read by the scanner 206 are displayed on the higher and the lower resolution display zone 135A, 135B, respectively. Since the image as well as the character information are displayed on the card 30, as described above, users can easily and readily understand necessary information. In addition, this card 30 is very convenient, since a photo needs not to be adhered on the card, unlike a conventional ID card.

The method for writing information on the card 30 using the displaying system 200 includes at least the steps of imaging by the digital camera or imaging device 204, reading character information by the scanner or reader 206, and writing the image and character information on the card by the read/write device 208. The written information is erased as needed, to prepare for the next writing. However, the next writing may be performed without separate erasing operation.

Since the read/write device 208 may read the information displayed on the card 30 to verify it, if necessary, the system 200 can also be used as a security system.

For example, the system 200 may be used for granting access to a secured area such as housing facility. In entering a housing facility, an exemplary procedure may include the following steps:

1) A visitor's name, company's name, purpose(s), or place(s) or department(s) to visit is filled in a form;

2) The form is provided to a receptionist who uses the scanner 206 to read the letters on the form;

3) The read characters are displayed on a display so that the receptionist verifies it;

4) The card 30 is positioned in the read/write device 208;

5) The digital camera 204 is used to take a picture of the visitor;

6) The PC 202 is controlled by the receptionist so that the data representative of the image and the character information is stored in a database and written on the card 30; and

7) The card 30 is provided to the visitor.

As described above, the card 30 continues to display the written information without requiring any power supply.

In leaving the facility, an exemplary procedure may include the following steps:

1) The card 30 is provided to the receptionist;

2) The card 30 is positioned in the read/write device 208 to read the image and the character information displayed on the card 30;

3) The data input in the entering procedure is read from the database in order to verify that the data from the database match the data read in the step 2);

4) If problems are found, an “abnormal condition” signal is input to the database;

5) If problems are not found, the visitor is permitted to leave the room or building and a “leave out” signal is input to the database; and

6) The information written on the card 30 is erased for further reuse.

The system in this embodiment can be used in various applications in which the card that displays information of a person or an object is used repeatedly.

For example, the system can be designed so that the card is used as passport of an amusement park, so that a visitor is identified when the visitor reenters the park. The system also allows other information to be displayed, such as the times a visitor has tried each attraction or a map of the amusement park.

The system can also be designed so that the card replaces a medical record or a nameplate of a newborn utilized in a clinic or hospital. For example, updating image or other information every day on the same card is easily and reliably performed, such as the image of a baby, which might be advantageous for the identification of the baby. Also, the image of a baby when it is awake can be seen even if the baby is asleep when visited.

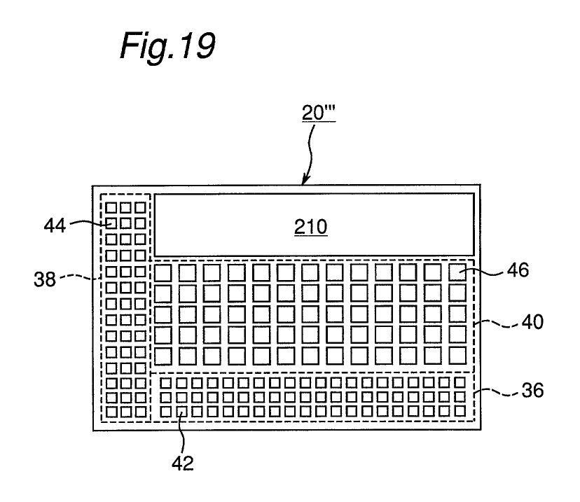

Although in the embodiment the reading element of the read/write device 208 is an optical reading device for optically reading a visual image displayed on the display region 34 of the card 30, a reading device for reading invisible information may be provided alternatively to or in addition to the optical reading device. Specifically, as shown in FIG. 19, a thin film of magnetic material 210 is provided on the terminal panel 20′″, for the purpose of providing access to a secured area such as housing facility, for example. In the entering procedure, data representative of character information and/or image of an object is recorded on the magnetic portion 210. In the leaving procedure, a magnetic reading device reads the recorded data on the portion 210 to verify it. Thus, the recording portion for invisible information allows much more information to be included in the display element.

Second Embodiment

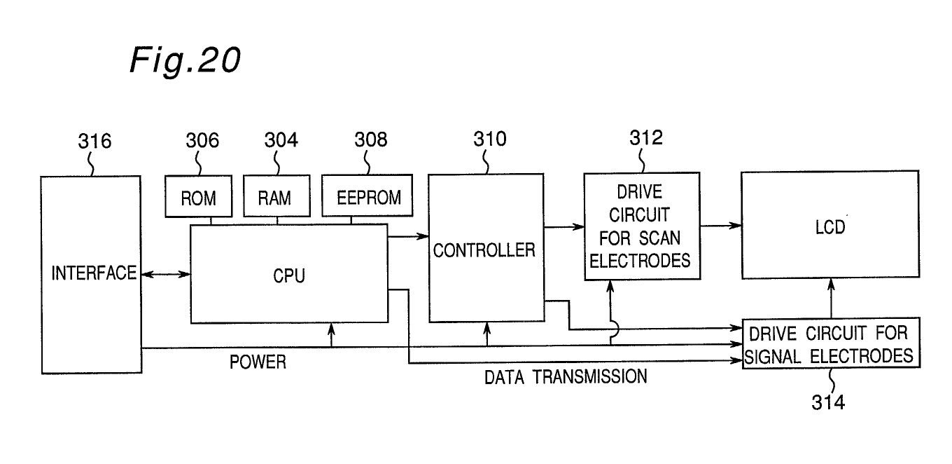

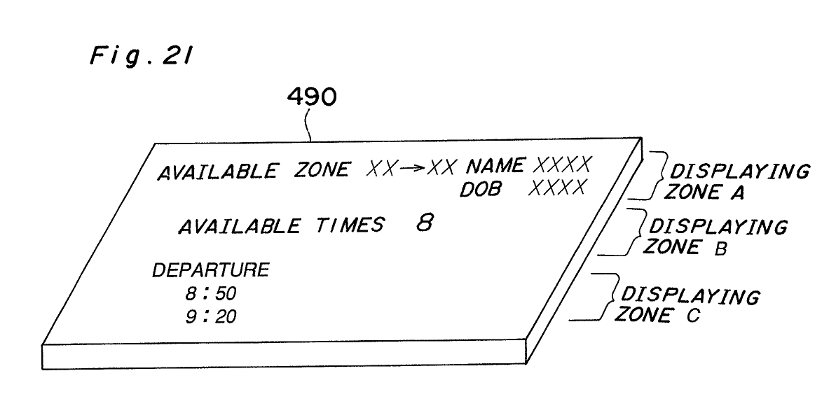

FIG. 20 is a block diagram of a second embodiment of the displaying system of according to the present invention, utilized as IC card with a CPU mounted therein. The CPU 302 is electrically connected with a RAM 304, a ROM 306, and an EEPROM 308 for recording data representative of character information and image of an object, which are updated when necessary. The CPU 302 is also electrically connected via a controller 310 with drive circuits 312, 314 for applying suitable voltages to the scan and the signal electrodes, respectively, so that the controller 310 controls the timing of the voltage application to display information on the IC card. Terminals 316 are provided on the card for electrically connecting with a read/write device so that the device transmits data signals to and receives them from the card. In this embodiment, since the control circuit is incorporated in the card, the arrangement or configuration of the terminals 316 can be simplified.

Although a power supply such as a battery or a solar cell may be incorporated in the card, it is preferable to supply power from an external device to the card only when writing and reading are performed, in order to utilize the memory characteristic of the LC i.e., the LCD can display information without any power supply.

In case the system is used for providing access to a secured area, for example, the system differs from that shown in FIG. 18 in that 1) data representative of character information and image of an object to be displayed on the card is transferred to the CPU of the card, so that the data is stored in the EEPROM, 2) driving operation is performed by the drive circuit provided within the card, and 3) the data is read from the EEPROM for the verification in the leaving procedure. Thus, since the storage element such as the EEPROM for storing data representative of image and/or additional information is incorporated in the card, the system has the advantages such as easier verification of the information displayed on the card, or an automation of the verification. In addition, since the drive circuit is incorporated in the card, the input device for inputting data to the card has a simpler construction of signal input terminals.

Third Embodiment

In this embodiment, the system is designed so that the card is used as coupon ticket available for a variety of transportation such as railroad. The displaying system includes a card, a write device with which a card issuer writes data on the card, and a read/write device which a card user makes update or read information on the card. An exemplary read/write device is a ticket inspector, as will be described hereinafter.

FIG. 21 is a perspective view of the card 490 displaying information thereon. The card 490 has the same configuration as the card 30 shown in FIG. 4. The display region is comprised of a display zone A in which an issuer writes information at issuance such as an available zone where a user can freely make use of the railroad, a display zone B in which information can be updated if necessary when the card is passed through the ticket inspector, and a display zone C in which information can be updated by the issuer and ticket inspector such as available times the user can still use the card. An exemplary available zone shown in FIG. 21 is a section defined between two stations.

The card 490 is designed so that the signal or row electrodes are extended across the display zones A, B, C. Thus, the electrodes are commonly used in the display zones A, B, C. On the other hand, the scan or column electrodes are composed of scan electrodes extending across the display zone A, scan electrodes across the display zone B, and scan electrodes across the display zone C. In synchronism with the voltage application, the signal electrodes extending across the display zones A, B, C are applied with respective signal voltages. However, as described above, the displaying state of the LC is not changed as long as the corresponding scan electrode is not applied with the voltage. Accordingly, for example, updating of the display zone B can be performed without changing the displaying state of the display zone A.

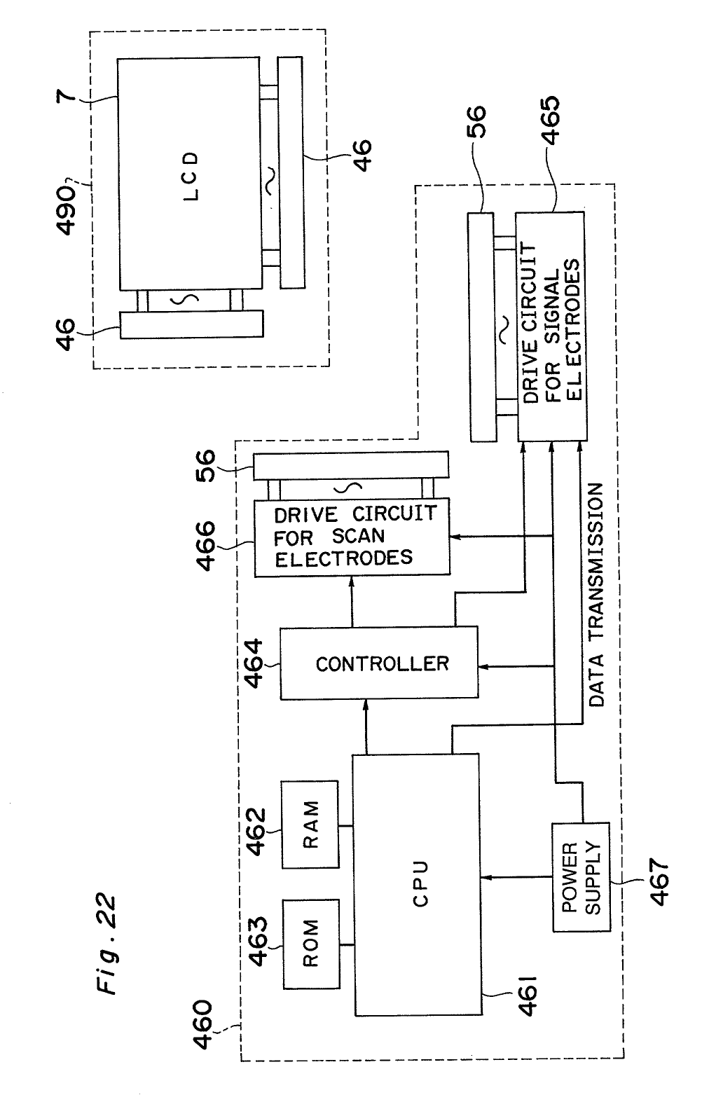

FIG. 22 is a block diagram of the card 490 and the write device 460 with which an issuer writes information on the card at issuance or selling. The write device 460 includes a CPU 461, which is electrically connected with a RAM 462, a ROM 463, a controller 464 for controlling the voltage application of drive circuits to write information on the card, the drive circuits 465, 466 for driving the signal and the scan electrodes, respectively, of the card 490, and a power supply 467. The connecting terminals 56, 56 for the connection thereof with the card 490 are electrically connected with the signal and the scan electrode drive circuits 465, 466, respectively. The card 490, on the other hand, includes a display panel 7, the scan and the signal electrodes thereof extended out to end sides of the display panel 7 to form connecting terminals 46 for the connection thereof with the terminals 56 of the write device 460. In writing operation, the terminals 56 of the write device 460 are connected with the terminals 46 of the card 490 so that the write device 460 drives the scan and the signal electrodes of the card 490 to display information on the card 490. The information to be written on the card 490 at issuance is identical to that on a ticket coupon generally used such as available times, available zone as shown in FIG. 21, or, if necessary, the user's name, sex, birthday, etc.

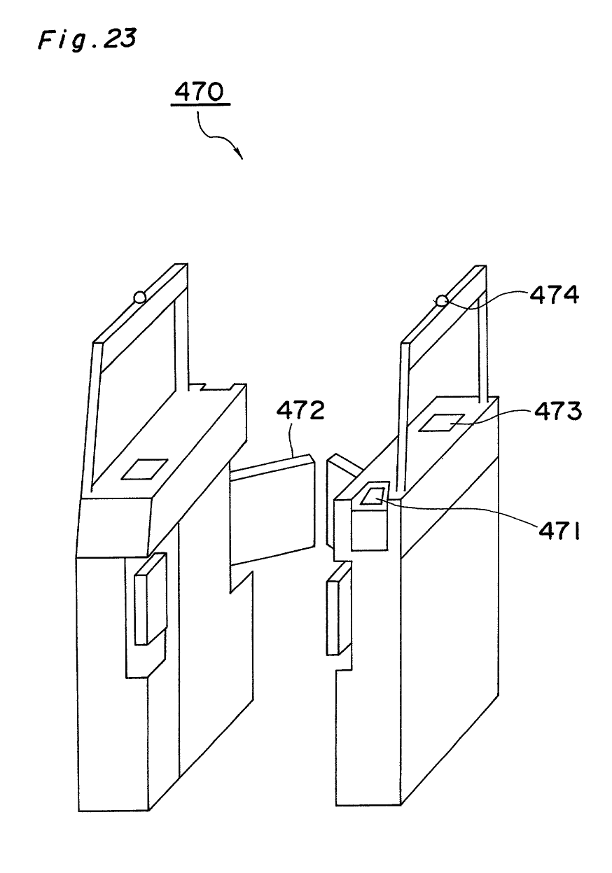

FIG. 23 is a perspective view of a read/write device 470 that a card user utilizes, which is an automated ticket inspector. In operation, when the card 490 is inserted from an insertion opening 471 into the ticket inspector 470, the gate 72 of the ticket inspector is opened or closed, or a warning light 74 is turned on when necessary, depending on the data included in the card and the setups of the ticket inspector. Then, suitable information is displayed on the display zones B and C. Finally, the card 490 is discharged onto the discharge portion 473.

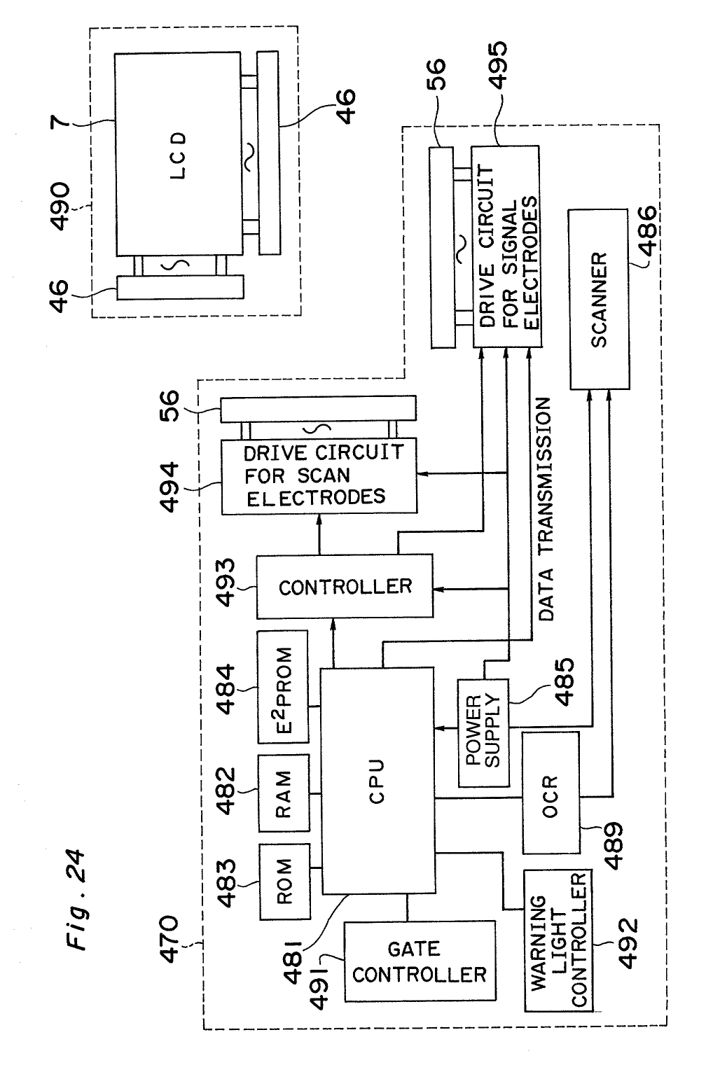

FIG. 24 is a block diagram of a ticket inspector or read/write device 470. The read/write device 470 includes a CPU 481, which is electrically connected with a RAM 482, a ROM 483, an EEPROM 484 for recording data to be written on the card, which is updated when necessary, a power supply 485, a scanner 486 for optically reading visual information on the card, and an OCR 489 for converting data signals representative of the visual information read by the scanner 486 into signals representative of character information. The CPU 481 is also electrically connected with a gate controller 491 and a warning light controller 492. The other elements for writing information on the card 490 such as controller 493, drive circuits 494, 495 are generally identical to the corresponding elements of the write device 460.

In writing and reading operation of the ticket inspector 470 described above, the scanner 486 reads the information displayed on the inserted card to transmit the corresponding data signals to the OCR 489, which converts the signals into the signals representative of character information. The CPU 481 receives the signals to control the gate controller 491, so that the gate is opened or closed. Simultaneously, the CPU 481 selects suitable data from the EEPROM 484 to write the corresponding information on the card. Although the OCR is used for recognizing characters read by the scanner, the OCR may be replaced by an image processor.

An exemplary procedure using the system will now be described in detail. The write device 460 is used by the issuer of the card or coupon ticket 490 to write the available zone, and if necessary the expiration date, the user's name or birthday, etc. on the display zone A, and the available times on the display zone C. The card 490 is then provided to the user.

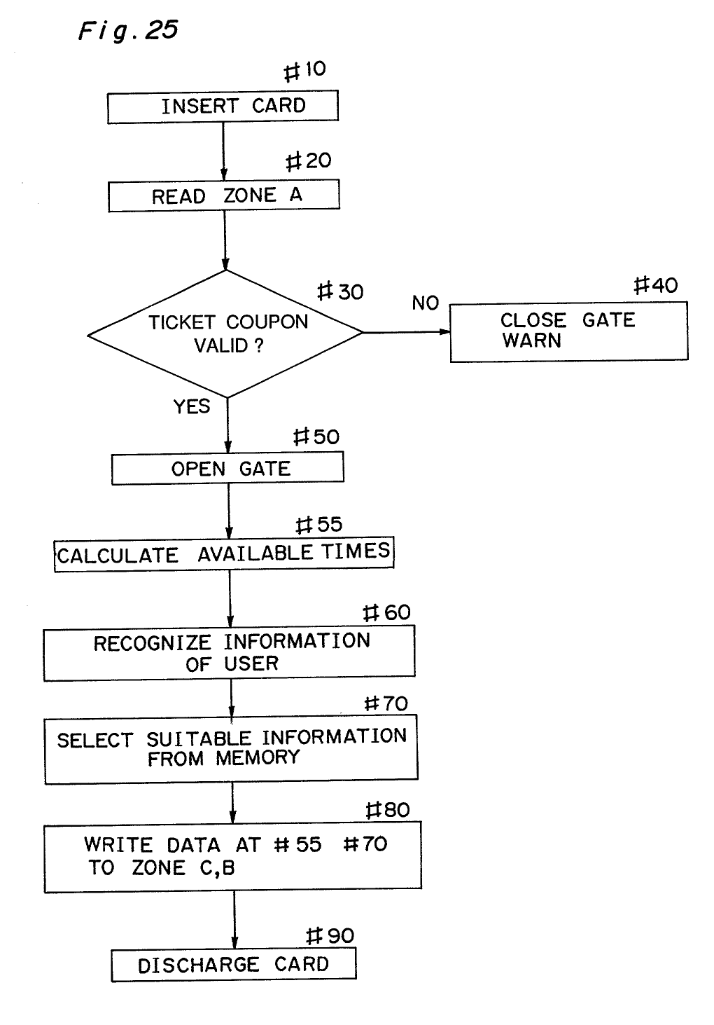

Referring now to FIG. 25 showing a flowchart of the operation of the ticket inspector 470, in some transport facilities where the card 490 is usable, the car 490 is inserted into a ticket inspector installed in a station (step #10). In the ticket inspector 470, the scanner 486 reads the information displayed on the display zones A and C of the card to transmit the corresponding data signals to the OCR 489, which converts them into the signals representative of character information (step #20). The CPU 481 determines if the ticket coupon is valid (step #30). If fare adjustment is needed or passing the entrance or exit is not permitted due to the fact that the station is not within the available zone, the date is expired, or available times are no longer left, the CPU 481 transmits signals to the gate controller 491, so that the gate 472 is closed, and to the warning light controller 492, so that the warning light 474 is turned on (step #40). If the card 490 or ticket coupon is valid, the CPU 481 transmits a signal to the gate controller 491, so that the gate 472 is opened (step #50), and, on the other hand, the CPU 481 calculates the remaining available times (step #55). Then, the CPU 481 recognizes information of the user or traveler read thereinto at step #20 (step #60). The information may be user's sex, age, direction in which the user is going to or coming from, or indicator that indicates whether the user enters or leaves the platform through the ticket inspector. It is noted that the direction can be estimated by comparing the station where the user is with the two stations of the available zone displayed on the card. The CPU 481 then retrieves information from the EEPROM 484, which may be suitable for the traveler, based on the information recognized at step #60 and the current time. At entering, the selected information may be a departure time of the next train or its arrival time at the destination displayed on the card. At leaving, the selected information may be a time schedule of the train bound for the departed station, a departure time of the last train, entertainment information near the arrival station, shopping information, or advertisements. The data stored in EEPROM 484 may be updated, if necessary, by a system operator. Next, the CPU 481 controls, via the controller 493, the scan electrode and the signal electrode drive circuits 494, 495 so that the remaining times calculated at step #55 is displayed on the display zone C of the card 490, and the data selected at step #70 on the display zone B (step #80). Finally, the card 490 is discharged onto the discharge portion of the ticket inspector, so that the card 490 goes back to the user or traveler (step #90). As described above, since the cholesteric LC material used in the card has the memory characteristic, the information on the card continues to be displayed without any power supply.

The card may be used as commuter ticket instead of ticket coupon. In this case, the flowchart is similar to that shown in FIG. 25, except that the calculation of the remaining times at step #55 and the writing of the times on the display zone C at step #80 are omitted.

The card may be designed so that the writing and displaying of additional information such as that in the display zone B in FIG. 21 is omitted. In this case, the ticket inspector only reads information such as available zone or expiration date.

It is noted that the card can be employed in various applications other than the railroad, where a card having available times such as ticket coupon or prepaid card, or card having an expiration date is used in general.

Fourth Embodiment

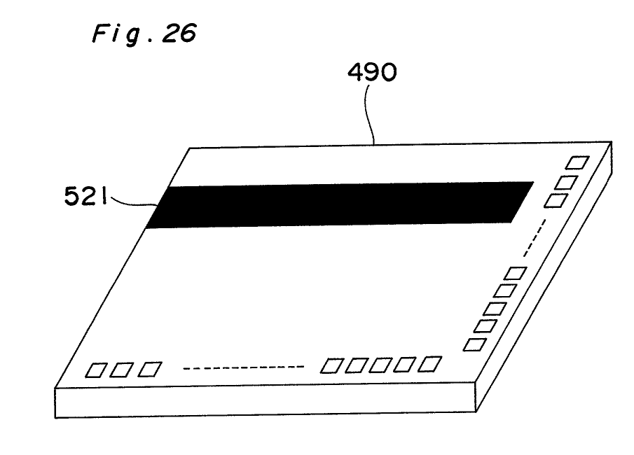

FIG. 26 is a perspective view of the card 490 or LCD with a magnetic recording portion 521. The magnetic recording portion 521 is provided on the front or rear surface, so that the card 490 displays visual information as well as stores information in the magnetic recording portion.

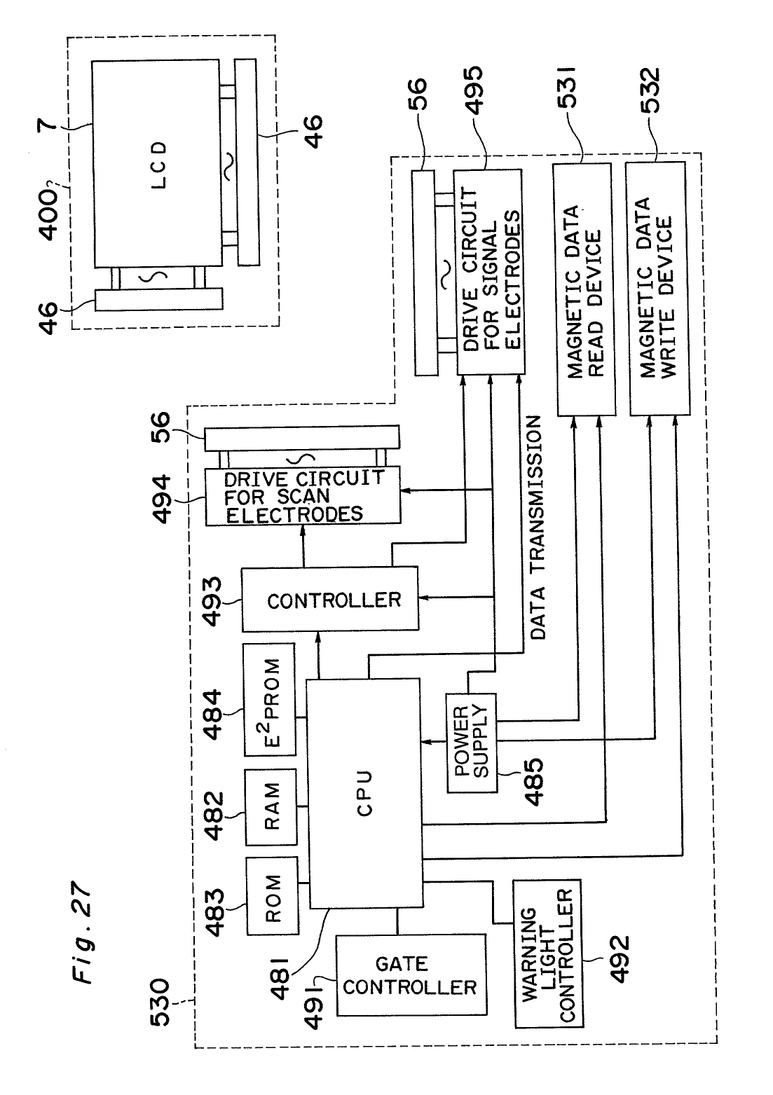

FIG. 27 is a block diagram of a read/write device 530 or second write device, which is a ticket inspector, of a fourth embodiment of the displaying system. The system is similar to that of the third embodiment except that the scanner 486 and the OCR 489 are replaced by read and write devices 531, 532 for reading and writing information on the magnetic recording portion 521, respectively. In addition, the write device not shown used by a card issuer may be a combination of the write device 50 in FIG. 7 for writing ticket information and another write device for magnetically writing data on the card. The ticket information may be an available zone, an expiration date, or available times. Preferably, the magnetic data is identical to the ticket information to be displayed on the card 490.

In operation of the system, like the third embodiment of the displaying system, the data representative of the ticket information is transmitted at issuance from the write device not shown to the card 490, so that the information is displayed on the display zones A and C of the card 490. At the same time, the same information is recorded in the magnetic recording portion 521. When a user of the card 490 inserts it into the ticket inspector 530, the magnetic data read device 531 reads the ticket information recorded in the magnetic recording portion 521. The CPU 481 of the ticket inspector 530 determines if the card 490 is valid, and controls the write device 532 based on the result so that the available times of the card 490 is written in the recording portion 521. At the same time, the CPU 481 controls the controller 493 so that the available times of the card 490 is displayed on the display zone C of the card 490. On the other hand, writing and displaying of additional information on the display zone B is performed in a similar way described in the third embodiment of the displaying system.

Fifth Embodiment

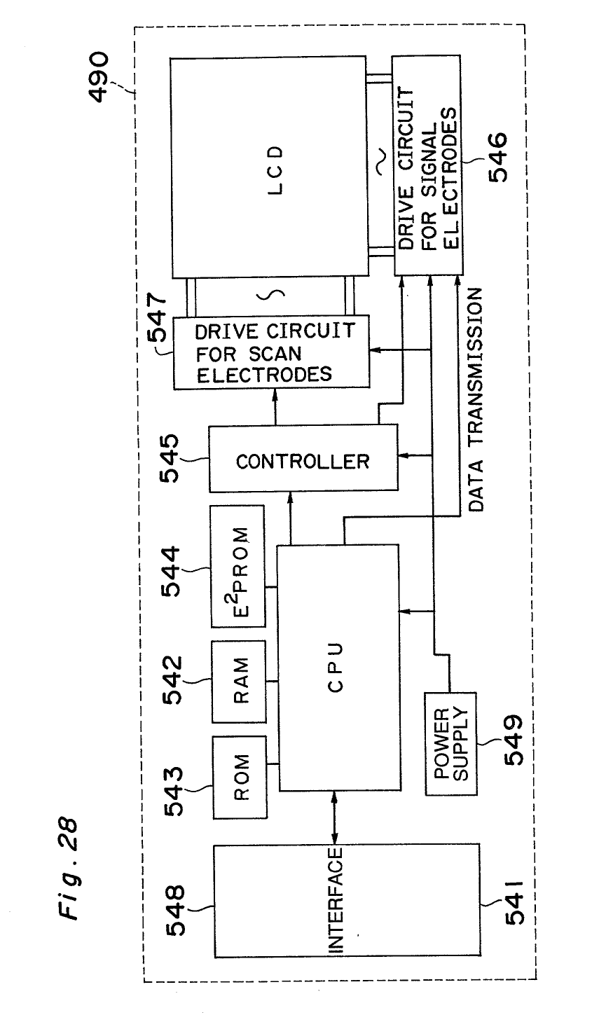

In this embodiment of the displaying system, the card is used as IC card having a CPU and a memory therein. FIG. 28 is a block diagram of the card 490 in the embodiment. The card 490 includes a CPU 541, which is electrically connected with a RAM 542, a ROM 543, an EEPROM 544 for recording data representative of ticket and/or user information, which is updated when necessary. The ticket information may be an available zone, an expiration date, or available times. The user information may be the user's sex or birthday.

The CPU 541 is also electrically connected with a controller 545 for controlling the voltage application of drive circuits to write information on the card, and the drive circuits 546, 547 for driving the signal and the scan electrodes, respectively. The drive circuits 546, 547 are electrically connected with the signal and the scan electrodes, respectively so that they apply suitable voltages to their respective electrodes to display information on the card 490. In addition, the card 490 includes an interface 548 for connecting the card 490 with the ticket inspector, and a power supply 549 for activating the CPU 541 of the card 490. The power supply 549 may be a battery or a solar cell. In this embodiment, data is transmitted serially between the ticket inspector and the card 490, which allows the number of electrodes of the interface 548 to be reduced.

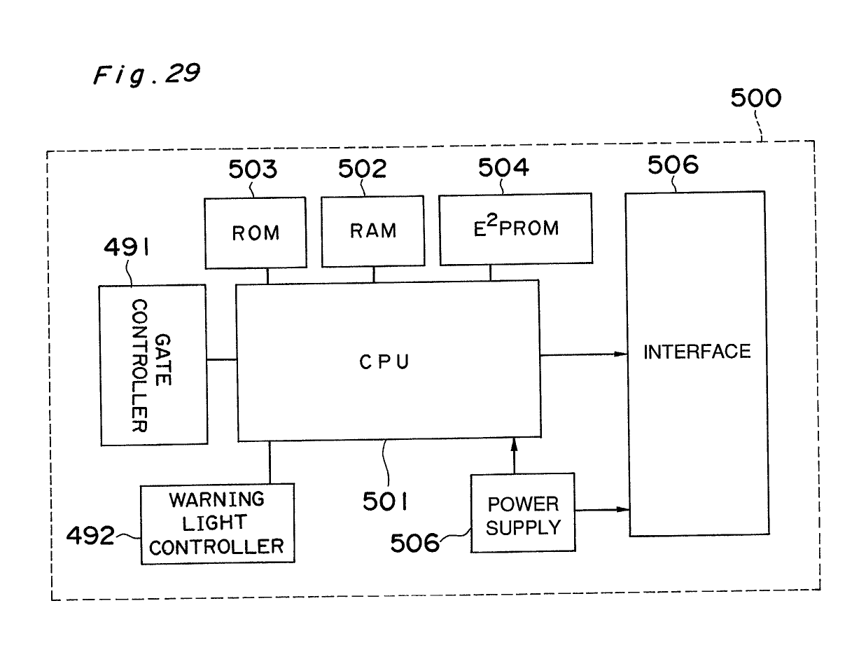

FIG. 29 is a block diagram of the ticket inspector 500 in the fifth embodiment of the displaying system. The ticket inspector 500 includes a CPU 501, which is electrically connected with a RAM 502, a ROM 503, an EEPROM 504 for recording data to be written on the card, which is updated when necessary, a power supply 505, an interface 506 for connecting the ticket inspector 500 with the card 490, the gate controller 491 and the warning light controller 492. The write device not shown used by a card issuer may have a similar configuration to that of the ticket inspector except that the write device is not provided with the gate controller 491, the warning light controller 492, and the EEPROM 504.

In operation of the system, the write device not shown transfers the data representative of ticket information and/or user information to the EEPROM 544 of the card 490 when it is issued. The CPU 541 of the card 490 controls the controller 545, so that the information corresponding to the transferred data is displayed on the display zones A and C. When the card 490 is inserted into the ticket inspector 500, the CPU 541 of the card 490 transfers the data representative of the ticket information stored in the EEPROM 544 to the ticket inspector 500. The CPU 501 of the ticket inspector 500 determines if the card 490 is valid, and then transfers the data representative of the available times and additional information to the card 490. The CPU 541 of the card 490 controls the controller 545 so that the remaining times and the additional information are displayed on the display zones B and C.

In this embodiment, since the CPU is incorporated in the card, a plurality of data having time-variable usefulness may be transferred to the card from the write device such as ticket inspector so that the data is stored in the memory of the card. Accordingly, in the course of time suitable data is retrieved from the stored data, so that the displayed information is automatically updated. For example, when a card user enters a station through the ticket inspector, the time schedules of trains available from at present time may be displayed and updated at any suitable time.

Sixth Embodiment

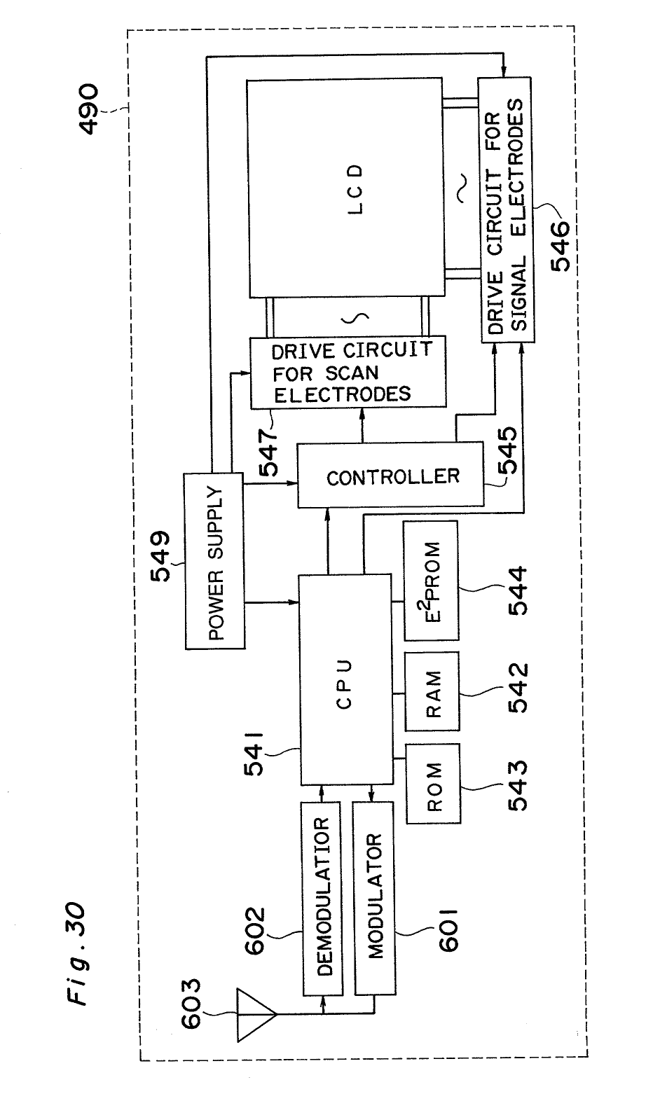

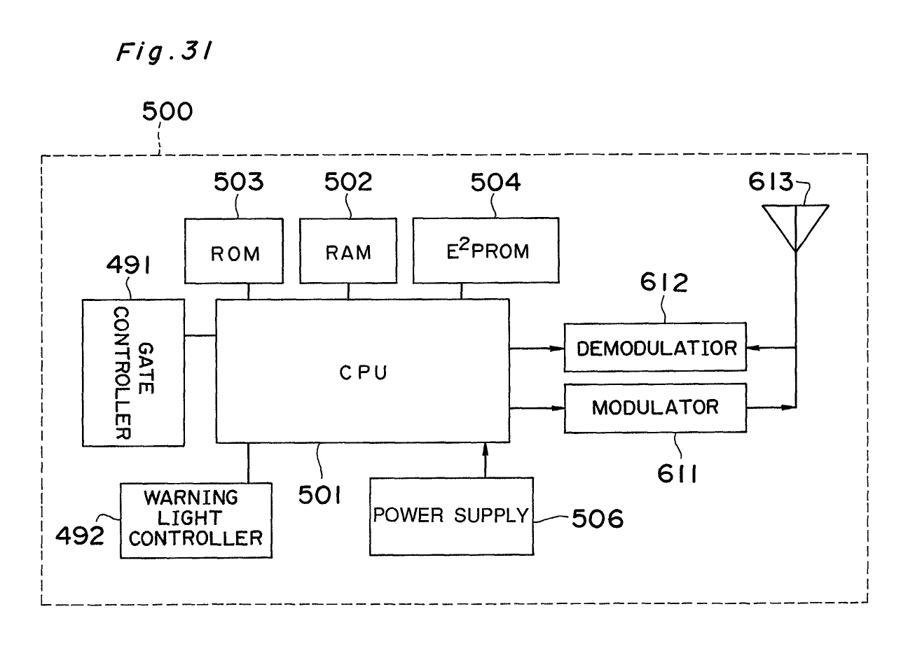

The system of the present embodiment is similar to that of the fifth embodiment except that the data is transferred between the card and the ticket inspector via radio wave. FIGS. 30 and 31 are block diagrams of the card 490 and the ticket inspector 500, respectively. Instead of the interface electrodes 506, 548 in the fifth embodiment, the card 490 and the ticket inspector 500 are provided with modulators 601, 611, demodulators 602, 612, and antennas 603, 613, respectively, so that data is transmitted and received as radio wave. The radio wave may be medium wave or microwave.

Although, with regard to the displaying system shown in the fifth and sixth embodiments, the power supply is incorporated in the card to supply power to the CPU of the card, the system may be designed so that the power is supplied from an external device to the card only when reading or writing is performed. An exemplary method of supplying power is directly connecting the terminals of the card and the read/write device. Alternatively, both the card and the read/write device may be provided with coils so that electromagnetic induction allows a power to be supplied from the read/write device to the card.

Seventh Embodiment

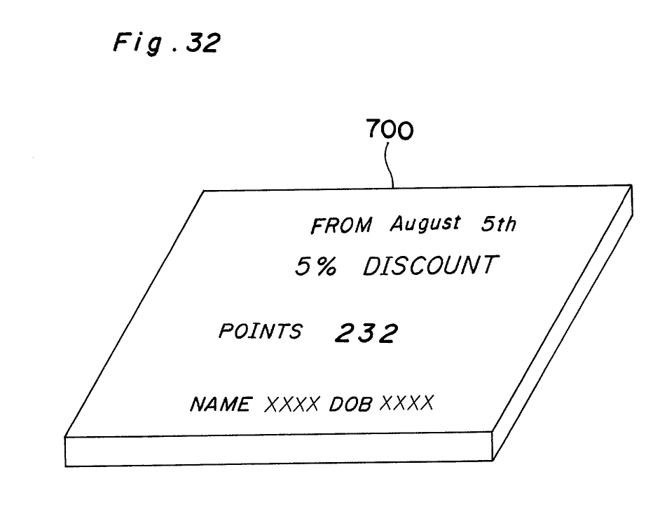

The displaying system according to the present invention may be used as rewarding system. The rewarding system is a system where points are added for the return of purchase in a store. FIG. 32 is a perspective view of an exemplary reward card 700. In this embodiment, a computer or terminal unit not shown in a store functions as a read/write device, which has been a ticket inspector in the previous embodiments. The terminal reads information such as customer's birthday, sex, or points from the card 700. In case where the system is designed so that customer's data is stored in a host computer connected with the terminal, only customer's ID may be recorded on the card. The terminal writes information such as added points for the return of purchase or advertisements of the store. The advertisements may be information selected based on the birthday or sex of the customer. In case where customer's data is stored in the host computer, they may be particular information based on what the customer has been purchasing or looking for.

What is claimed is:

1. A liquid crystal display, comprising:
a first substrate having a surface, said surface supporting thereon a plurality of first electrodes each extending in a certain direction;
a second substrate having a first surface and a second surface opposed to said first surface, said first surface supporting thereon a plurality of second electrodes each extending in a certain direction, said second substrate being positioned so that said first surface opposes said surface of said first substrate to define a gap therebetween and said first and second electrodes cross with each other;
a memory type liquid crystal filled in said gap; and
a plurality of first and second terminals positioned on said second surface and electrically connected with said first and second electrodes, respectively, so that said first and second terminals are capable of being connected with an external device that transmits signals through said first and second terminals to said first and second electrodes, respectively.

2. A liquid crystal display in accordance with claim 1, wherein said second surface of said second substrate supports a panel, said panel bearing thereon said first and second terminals and a plurality of electric lines, said electric lines connecting between said first and second terminals and said first and second electrodes, respectively.

3. A liquid crystal display in accordance with claim 1, wherein said first and second terminals are exposed on a back side of said liquid crystal display.

4. A liquid crystal display in accordance with claim 3, wherein said first and second terminals are arranged in a form of matrix.

5. A liquid crystal display, comprising:
a first displaying layer, having a first surface and a second surface opposed to said first surface;
a second displaying layer, having a third surface and a fourth surface opposed to said third surface, said second displaying layer being positioned so that said third surface opposes said second surface of said first displaying layer;
each of said first and second displaying layers having
first and second substrates spaced apart from the other to define a gap therebetween;
first electrodes positioned on one of said first and second substrates;
second electrodes positioned on the other of said first and second substrates; and
a memory type liquid crystal filled in said gap; and
a plurality of terminals for connecting said first and second electrodes of said first and second display layers with an external device, said terminals being positioned on said fourth surface of said second displaying layer and electrically connected with said first and second electrodes of said first and second display layers.

6. A liquid crystal display in accordance with claim 5, wherein each of said first electrodes in said first displaying layer is provided in a one-to-one correspondence with each of said first electrodes in said second displaying layer, and said terminals include common electrodes, each of said common electrodes being connected with said corresponding first electrodes in said first and second displaying layers.

7. A liquid crystal display in accordance with claim 5, wherein each of said second electrodes in said first displaying layer is provided in a one-to-one correspondence with each of said second electrodes in said second displaying layer, and said terminals include common electrodes, each of said common electrodes being connected with said corresponding second electrodes in said first and second displaying layers.

8. A liquid crystal display in accordance with claim 1, further comprising
an indicator indicating a feature of any one of said first and second electrodes and said terminals.

9. An apparatus for transmitting data into a liquid crystal display, said liquid crystal display includes
a first substrate having a surface, said surface supporting thereon a plurality of first electrodes each extending in a certain direction;
a second substrate having a first surface and a second surface opposed to said first surface, said first surface supporting thereon a plurality of second electrodes each extending in a certain direction, said second substrate being positioned so that said first surface opposes said surface of said first substrate to define a gap therebetween and said first and second electrodes angles with each other;
a memory type liquid crystal filled in said gap; and
a plurality of first and second terminals positioned on said second surface and electrically connected with said first and second electrodes, respectively,
comprising:
a plurality of outputs provided for said terminals, respectively; and
a circuit for transmitting signals of an image through said outputs to said terminals associated thereto.

10. An apparatus for transmitting data into a liquid crystal display, said liquid crystal display includes
a first displaying layer, having a first surface and a second surface opposed to said first surface;
a second displaying layer, having a third surface and a fourth surface opposed to said third surface, said second displaying layer being positioned so that said third surface opposes said second surface of said first displaying layer;
each of said first and second displaying layers having
first and second substrates spaced apart from the other to define a gap therebetween;
first electrodes positioned on one of said first and second substrates;
second electrodes positioned on the other of said first and second substrates; and
a memory type liquid crystal filled in said gap; and
a plurality of terminals for connecting said first and second electrodes of said first and second display layers with an external device, said terminals being positioned on said fourth surface of said second displaying layer and electrically connected with said first and second electrodes of said first and second display layers.
comprising:
a plurality of outputs provided for said terminals, respectively; and
a circuit for transmitting signals of an image through said outputs to said terminals associated thereto.

11. A display apparatus, comprising:
a panel; and
a plurality of display zones positioned on one surface of said panel;
each of said display zones having
a plurality of first electrodes extending in one direction;
a plurality of second electrodes extending in another direction angled with said one direction; and
a light modulator positioned between said first and second electrodes;
wherein in each of said display zones said first and/or second electrodes are arranged in a manner different from that in another display zone.

12. A display apparatus in accordance with claim 11, wherein in each of said display zones said first and/or second electrodes are arranged in a parallel fashion at certain intervals, said interval being different from that in another display zone.

13. A display apparatus in accordance with claim 11, wherein in each of said display zones the number of said first and/or second electrodes per inch is different from that in another display zone.

14. A display apparatus in accordance with claim 11, wherein said one of said first and second electrodes'in one display zone is also commonly used for the one of said first and second electrodes in another display zone.

15. A display apparatus in accordance with claim 14, wherein said commonly used electrodes are extended linearly.

16. A display apparatus in accordance with claim 14, wherein said commonly used electrodes are angled at between said zones where said electrodes are commonly used.

17. A display apparatus in accordance with claim 11, wherein said substrate supports on an opposite surface thereof a plurality of terminals connected with said electrodes for connecting said terminals with an external device.

18. A display apparatus, comprising:
a first displaying layer, having a first surface and a second surface opposed to said first surface;
a second displaying layer, having a third surface and a fourth surface opposed to said third surface, said second displaying layer being positioned so that said third surface opposes said second surface of said first displaying layer, said first and second displaying layers associating with each other to define a first display zone having a first resolution and a second display zone having a second resolution which is different from said first resolution.

19. A display apparatus in accordance with claim 18, wherein each of first and second displaying layers has first parallel electrodes in one direction and second parallel electrodes extending in another direction, and the number of first and/or second electrodes per inch in said first display zone is different from that in said second display zone.

20. A display apparatus in accordance with claim 18, wherein said second displaying layer supports on said fourth surface thereof a plurality of terminals connected with said electrodes for connecting said terminals with an external device.

21. A liquid crystal display, comprising:
a first surface and a second surface opposed to said first surface; and
color and monochrome display zones each for displaying color and monochrome images in said first surface;
each of said color and monochrome display zones having a plurality of liquid crystal displaying layers superimposed one on top the other;
each of said liquid crystal displaying layers having
a pair of opposed substrates spaced apart from the other;
first electrodes supported on one of said substrates;
second electrodes supported on the other of said substrates; and
a liquid crystal provided between said opposed substrates;
said liquid crystal display further comprising an input for inputting an identical signal to said each of electrodes in said monochrome zone.

22. A liquid crystal display in accordance with claim 21, wherein in said monochrome zone said first electrodes in each liquid crystal displaying layer are electrically connected to another.

23. A liquid crystal display in accordance with claim 21, wherein said one of said first and second electrodes in said color display zone is also commonly used for the one of said first and second electrodes in said monochrome display zone.

24. A liquid crystal display in accordance with claim 21, wherein the liquid crystal displaying layers of each of said color and monochrome display zones are red, green and blue color displaying layers.

25. A liquid crystal display in accordance with claim 21, wherein said second surface of said liquid crystal display supports a plurality of terminals connected with said electrodes are supported for connecting said terminals with an external device.

26. A displaying system, comprising:
a display element having
a memory type display panel, said display panel having a pair of opposed substrates, first electrodes supported on one of said opposed substrate and second electrodes supported on the other of said opposed substrate, and a light modulator positioned between said opposed substrates; and
a circuit having a plurality of terminals and a plurality of wires for connecting said terminals with said first or second electrodes;
a digital image pickup for picking up an image; and
a data transmitter for transmitting a signal representative of said image to said terminals of said display element.

27. A displaying system in accordance with claim 26, further comprising another data transmitter for transmitting a signal representative of additional information to said terminals of said display element the display element.

28. A displaying system in accordance with claim 26, further comprising a read device for reading information displayed on the display element.

29. A displaying system in accordance with claim 26, wherein said display element includes a plurality of display zones.

30. A displaying system in accordance with claim 29, wherein said display zones include a first display zone having a first resolution and a second display zone having a second resolution which is different from said first resolution.

31. A displaying system in accordance with claim 26, wherein the display element includes a surface on which said terminals are arranged in a form of matrix.

32. A displaying system in accordance with claim 26, wherein the display element includes a drive circuit therein for driving said first and second electrodes.

33. A displaying system in accordance with claim 26, wherein the display element is provided with a portion for recording invisible information readable by an external read device.

34. A displaying system, comprising:
a liquid crystal display element, said liquid crystal display includes
a first substrate having a surface, said surface supporting thereon a plurality of first electrodes each extending in a certain direction;
a second substrate having a first surface and a second surface opposed to said first surface, said first surface supporting thereon a plurality of second electrodes each extending in a certain direction, said second substrate being positioned so that said first surface opposes said surface of said first substrate to define a gap therebetween and said first and second electrodes angles with each other;
a memory type liquid crystal filled in said gap; and
a plurality of first and second terminals positioned on said second surface and electrically connected with said first and second electrodes, respectively;
a write device for inputting a first data to said liquid crystal display element; and
a read device for reading said first data from said element.

35. A displaying system, comprising:
a liquid crystal display element, said liquid crystal display includes
a first substrate having a surface, said surface supporting thereon a plurality of first electrodes each extending in a certain direction;
a second substrate having a first surface and a second surface opposed to said first surface, said first surface supporting thereon a plurality of second electrodes each extending in a certain direction, said second substrate being positioned so that said first surface opposes said surface of said first substrate to define a gap therebetween and said first and second electrodes angles with each other;
a memory type liquid crystal filled in said gap; and
a plurality of first and second terminals positioned on said second surface and electrically connected with said first and second electrodes, respectively;
a write device for inputting a first data to said liquid crystal display element; and
a read/write device designed so that it reads said first data from said element and then writes second data based on said first data.

36. A displaying system in accordance with claim 34, wherein said liquid crystal display element further includes a portion for recording said first data representative of the information to be displayed on said element.

37. A displaying system in accordance with claim 34, wherein said liquid crystal display element includes a circuit therein for driving said element.

38. A displaying system in accordance with claim 37, wherein said liquid crystal display element and said write device are designed so that said first data is transmitted via radio wave between said element and said write device.

39. A displaying system in accordance with claim 34, wherein said liquid crystal display element is a commuter ticket or ticket coupon.

40. A displaying system in accordance with claim 34, wherein said liquid crystal display element is a reward card.

41. A display comprising:
a displaying layer being capable of maintaining information displayed thereon without energy consumption, said displaying layer having a plurality of first electrodes and a plurality of second electrodes; and
a plurality of terminals, for being electrically connected with an external device, provided on a rear side of said display, said terminals being connected with said first and second electrodes, respectively.

42. A display in accordance with claim 41, further comprising:
a support panel disposed on a side far from a viewing side of said display with respect to said displaying layer, said support panel bearing thereon said terminals and a plurality of electric lines for connecting between said terminals and said first and second electrodes, respectively.

43. A display in accordance with claim 41, wherein said terminals are arranged in a form of matrix.
